(19) United States
(12) Patent Application Publication
(10) Pub. No.: US 2026/0313537 A1
(43) Pub. Date: Oct. 8, 2026

(54) MANAGING DATA COMMUNICATION FOR POWER SAVING

(71) Applicant: GOOGLE LLC, Mountain View (CA)

(72) Inventor: Chih-Hsiang Wu, Taoyuan City (TW)

(21) Appl. No.: 19/483,441

(22) PCT Filed: May 13, 2024
(86) PCT No.: PCT/US2024/029145

§ 371 Date: Nov. 11, 2025

Related U.S. Application Data
(60) Provisional application No. 63/501,668, filed on May 11, 2023.

(51) Int. Cl. H04W 52/02; H04W 76/28; H04W 88/08

(52) U.S. Cl. CPC H04W 52/0206; H04W 76/28; H04W 88/085

(57) ABSTRACT

A method (1800) communicating downlink data packets between a core network (CN) and a user equipment (UE) is implemented in the RAN. The method comprises communicating (1802), between the CN and the UE, the data packets; receiving (1856), from the CN, an indication of an end of a data burst that includes the data packets; and transmitting, (1890) to the UE and in response to the receiving of the indication, a command related to a power saving mode.

### CROSS-REFERENCE TO RELATED APPLICATION

This application claims priority to and the benefit of the filing date of provisional U.S. Patent Application No. 63/501,668 entitled “Managing Data Communication for Power Saving” filed on May 11, 2023. The entire content of the provisional application is hereby expressly incorporated herein by reference.

### FIELD OF THE DISCLOSURE

This disclosure relates to wireless communications and, more particularly, to managing data communication for power saving.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer. A core network communicates data with the UE via the RAN using multiple layers of a protocol stack.

Some of the services fifth-generation systems (5GS) require a high data rate and low-latency transmissions. One example of such services is extended Reality (XR), which includes Augmented Reality (AR), Virtual Reality (VR), and Mixed Reality (MR). In virtual reality applications, the user is fully immersed in a virtual environment that fully replaces the real, physical environment, typically by wearing a head-mounted device. In augmented reality, an application augments the perception of the real environment by overlaying virtual elements on the perception of the real environment. Augmented reality recently became the foundation of a widely popular game in which players seek out and interact with virtual creatures superimposed onto a real-time video stream of the real world. Finally, mixed reality is an extension of AR, where real and virtual elements can interact in real time.

XR games and other applications often run on cloud platforms that include remote servers, and generally do not require games consoles, high-spec CPUs, or high-spec GPUs. Cloud gaming involves streaming a game similar to streaming a video, and the game responds to the gamer's commands and controls in real time.

In some cases, services associated with high data rates and low latencies produce data traffic with bursty transmission characteristics. Devices in other words do not transmit or receive data continuously, but rather do so in short bursts. For example, an application may generate a burst of data when the user clicks on a link, but after this event there may be a relatively long period of time with no data transmissions. Another example is an application that generates different amounts of data periodically, such as a video game that updates the screen every few milliseconds.

Bursty data traffic can have a significant impact on the power consumption of a UE, as the UE must be constantly listening for data, even when there is no data to be received. Moreover, the UE must transmit control signals to the base station, even when there is no data to be sent.

### SUMMARY

An example embodiment of the techniques of this disclosure is a method for communicating downlink data packets between a core network (CN) and a user equipment (UE) the method implemented in a radio access network (RAN) node. The method comprises communicating, between the CN and the UE, the data packets; receiving, from the CN, an indication of an end of a data burst that includes the data packets; and transmitting, to the UE and in response to the receiving of the indication, a command related to a power saving mode.

Another example embodiment of these techniques is a user equipment (UE) comprising: a transceiver; and a processing hardware configured to implement the method above.

Yet another example embodiment of these techniques is method in a radio access network (RAN) for communicating data packets between the RAN and a user equipment (UE). The method comprises configuring the UE to report an end of a data burst; communicating, with the UE, data packets associated with the data burst; and receiving, from the UE, an indication of the end of the data burst.

Still another example embodiment of these techniques is a radio access network (RAN) comprising one or more transceivers; and a processing hardware configured to implement the method above.

### BRIEF DESCRIPTION OF THE DRAWINGS

FIG. 1A is a block diagram of an example system in which one or more base stations and/or a user equipment (UE) can implement the techniques of this disclosure for managing data communication for power saving between the UE and a radio access network (RAN).

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3A is a messaging diagram of an example scenario in which a UE reports the end of a data burst in an uplink (UL) PDU, along with the last data packet of the data burst, and receives a modification to a discontinuous reception (DRX) operation of the UE;

FIG. 3B is a messaging diagram of an example scenario similar to that of FIG. 3A, but in which the UL PDU does not include any data packets;

FIG. 3C is a messaging diagram of an example scenario in which a UE reports the end of a data burst in a UL lower-layer PDU, along with the last data packet of the data burst;

FIG. 3D is a messaging diagram of an example scenario in which a central unit (CU) of a distributed base station reports the end of a data burst to a distributed unit (DU), and the DU transmits, to the UE, a modification to the DRX operation of the UE;

FIG. 3E is a messaging diagram of an example scenario similar to that of FIG. 3A, but in which the UE transmits a request to modify the DRX operation of the UE;

FIGS. 4 and 5 are flow diagram of example method for managing data bursts, which can be implemented in a RAN node;

FIG. 6 is a flow diagram of example method for managing data bursts, which can be implemented in a control plane (CP) of a RAN;

FIGS. 7-9C are flow diagrams of example methods for managing data bursts, which can be implemented in a user plane (UP) of a RAN;

FIGS. 10-12 are flow diagrams of example methods for managing data bursts, which can be implemented in a distributed unit (DU) of a distributed base station;

FIG. 13 is a flow diagram of example method for managing data bursts, which can be implemented in a RAN node;

FIGS. 14-16B are flow diagrams of example methods for managing data bursts, which can be implemented in a UE;

FIGS. 17A and 17B illustrate example DRX operations;

FIG. 18 is as flow diagram of an example method for communicating downlink packets between a core network (CN) and a user equipment (UE); and

FIG. 19 is a flow diagram of an example method implemented in a UE for communicating data packets between the UE and a CN via a RAN.

### DETAILED DESCRIPTION OF THE DRAWINGS

Using the techniques discussed below, a radio access network (RAN) node can cause a user equipment (UE) to enter a power saving mode, or modify the previously configured power saving mode, in view of a status of a downlink and/or uplink data burst. The UE also can determine when to activate or power the power saving mode in view of the end of a data burst.

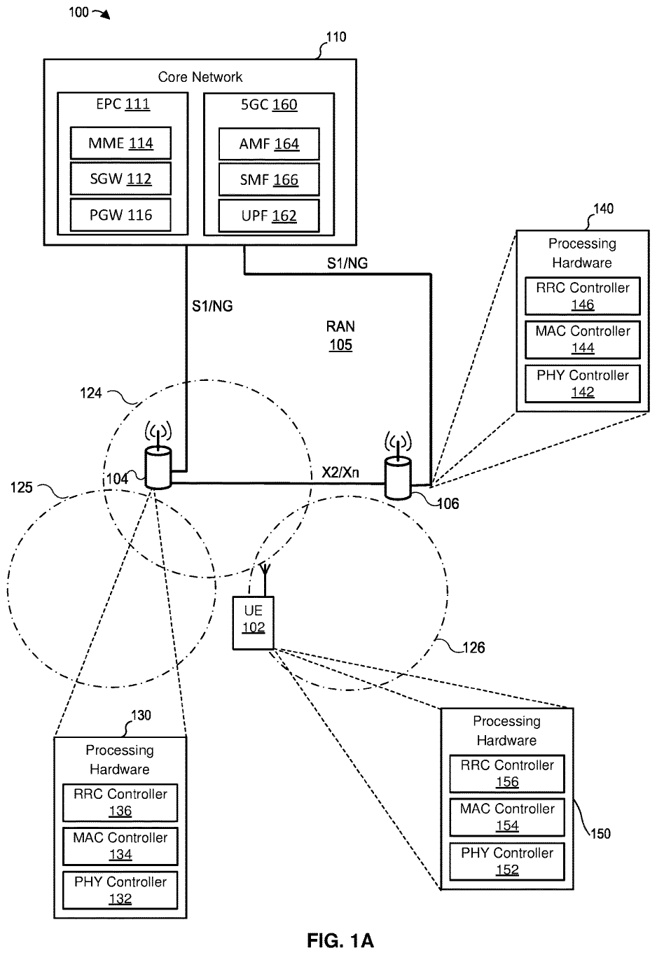

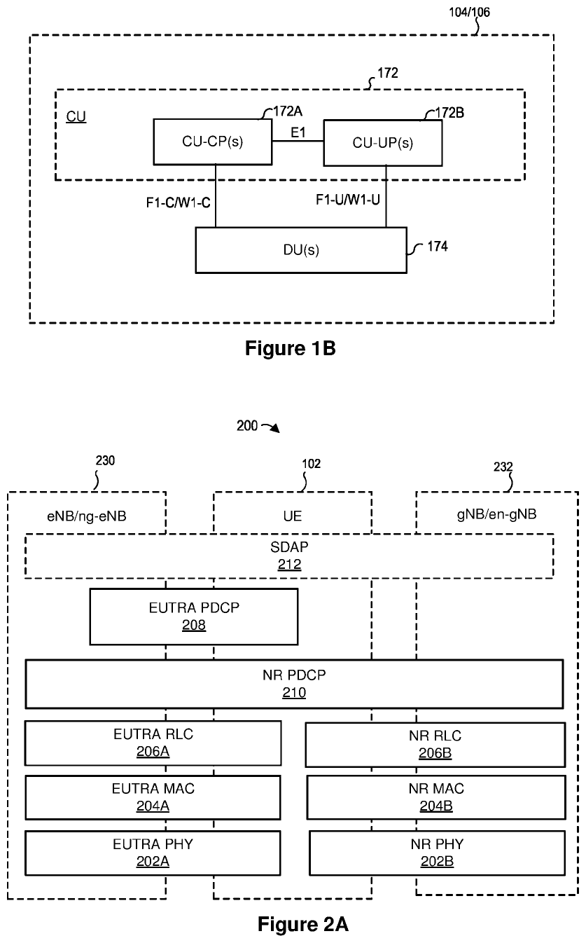

FIG. 1A depicts an example wireless communication system 100 in which communication devices can implement these techniques. The wireless communication system 100 includes a UE 102, a base station 104 (source BS 104), a base station 106 (operating in the handover scenarios discussed below as the target BS 106, and a core network (CN) 110. The UE 102 initially connects to the base station 104. The base stations 104 and 106 can operate in a RAN 105 connected to the CN 110. The CN 110 can be implemented as an evolved packet core (EPC) 111 or a fifth generation (5G) core (5GC), 160, for example.

Among other components, the EPC 111 can include a Serving Gateway (SGW) 112, a Mobility Management Entity (MME) 114, and a Packet Data Network Gateway (PGW) 116. Generally speaking, the SGW 112 is configured to transfer user-plane packets related to audio calls, video calls, Internet traffic, etc., and the MME 114 is configured to manage authentication, registration, paging, and other related functions. The PGW 116 provides connectivity from the UE to external packet data networks including Internet network and/or an Internet Protocol (IP) Multimedia Subsystem (IMS) network by being the point of exit and entry of traffic for the UE. The 5GC 160 includes a User Plane Function (UPF) 162, an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The base station 104 can additionally supports a cell 125. The cells 124 and 125 can partially overlap, so that while communicating with the UE 102 via the cell 124, the base station 104 hands over the UE 102 to the cell 125. The cells 124 and 126 can partially overlap, so that while communicating with the UE 102 via the cell 124, the base station 104 hands over the UE 102 to the base station 106 operating as a target base station. To directly exchange messages during handover scenarios discussed below, the base station 104 and the base station 106 can support an X2 or Xn interface. In general, the CN 110 can connect to any suitable number of base stations supporting NR cells and/or EUTRA cells.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g., UE 102) via one or more cells and/or one or more TRPs. The PHY controller 132 is also configured to receive data and control signal on physical uplink (UL) channels and/or UL reference signals with the one or more user devices via one or more cells and/or one or more TRPs. The processing hardware 130 in an example implementation includes a MAC controller 134 configured to perform MAC functions with one or more user devices. The MAC functions include a random access (RA) procedure, managing UL timing advance for the one or more user devices, and/or communicating UL/DL MAC PDUs with the one or more user devices. The processing hardware 130 can further include a RLC controller (not show in FIG. 1A) configured to perform RLC functions with one or more user devices. The processing hardware 130 can further include a PDCP controller (not show in FIG. 1A) configured to perform PDCP functions with one or more user devices. The processing hardware 130 can further include an RRC controller 136 to implement procedures and messaging at the RRC sublayer of the protocol communication stack. For example, the RRC controller 132 may be configured to support RRC messaging associated with resource configuration, measurement configuration procedure and reconfiguration procedure and/or handover procedures. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells and/or one or more TRPs. The PHY controller 152 is also configured to transmit data and control signal on physical UL channels and/or UL reference signals with the base station 104 or 106 via one or more cells and/or one or more TRPs. The processing hardware 150 in an example implementation includes a MAC controller 154 configured to perform MAC functions with base station 104 or 106. For example, the MAC functions include a random-access procedure, managing UL timing for communication with the base station 104 or 106, and communicating UL/DL MAC PDUs with the base station 104 or 106. The processing hardware 150 can further include an RRC controller 156 to implement procedures and messaging at the RRC sublayer of the protocol communication stack. The processing hardware 150 can further include a RLC controller (not show in FIG. 1A) configured to perform RLC functions with the base station 104 or 106. The processing hardware 150 can further include a PDCP controller (not show in FIG. 1A) configured to perform PDCP functions with the base station 104 or 106.

FIG. 1B depicts an example, distributed or disaggregated implementation of any one or more of the base stations 104, 106. In this implementation, the base station 104, 106 includes a central unit (CU) 172 and one or more DUs 174. Each of the DU(s) can operate one or more cells. For example, the base station 104 includes a DU operating the cell 124 and/or cell 125. In another example, the base station 104 includes a DU 174A and a DU 174B that operate the cell 124 and the cell 125, respectively. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include an RRC controller such as RRC controller 136, 146. The CU 172 can a PDCP controller and/or a Service Data Adaptation Protocol (SDAP) controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or SDAP protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the El interface. The CU-CP 172A selects the appropriate CU-UP 172B for the requested services for the UE 102. In some implementations, a single CU-UP 172B can be connected to multiple CU-CP 172A through the El interface. The CU-CP 172A can be connected to one or more DU 174s through an F1-C or W1-C interface. The CU-UP 172B can be connected to one or more DU 174 through an F1-U or W1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

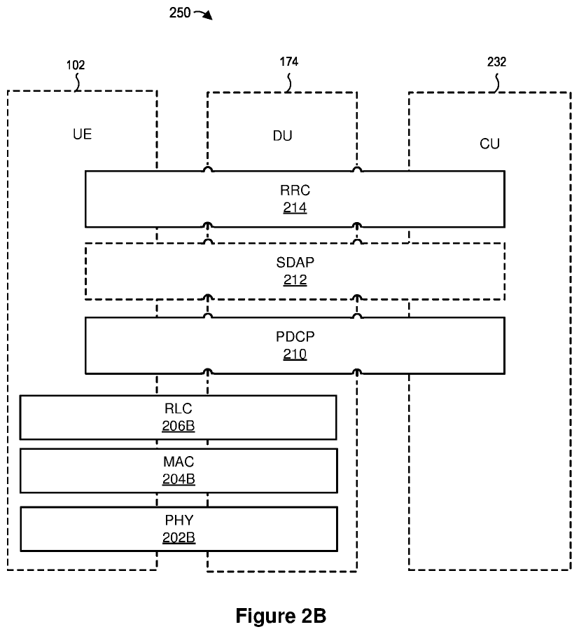

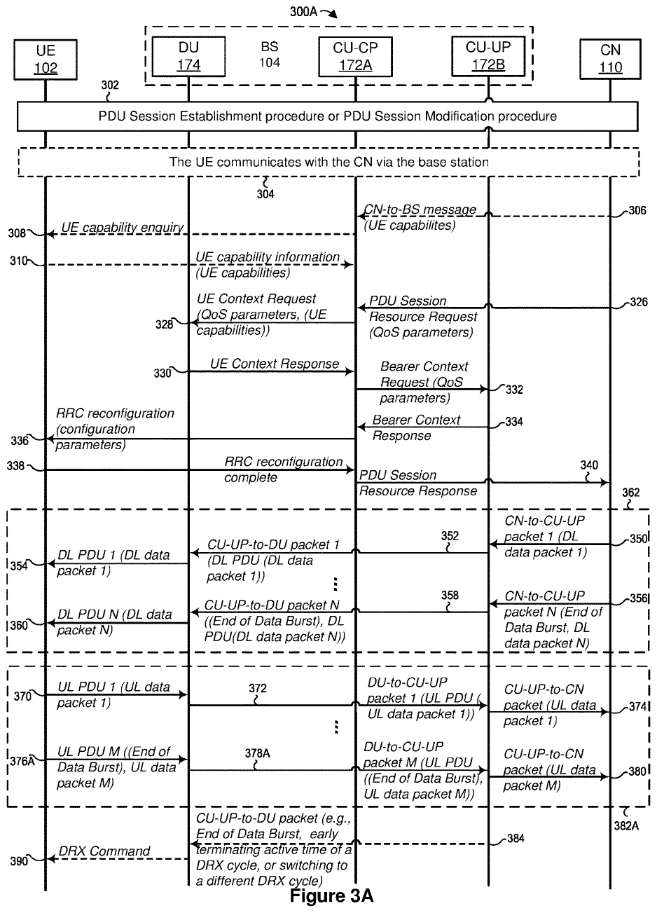

FIG. 2A illustrates, in a simplified manner, an example protocol stack 200 according to which the UE 102 can communicate with an eNB/ng-eNB 230 or a gNB 232 (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

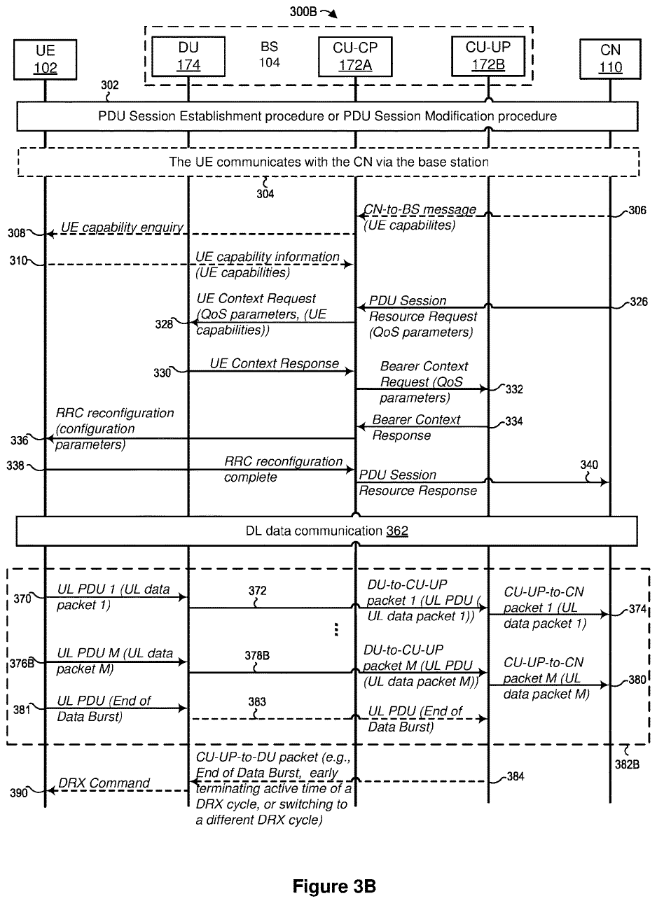

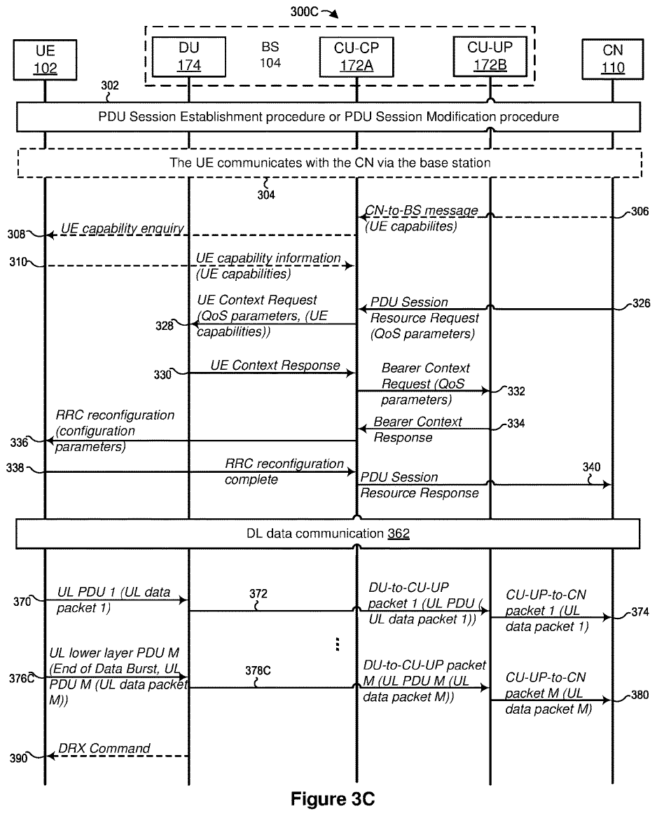

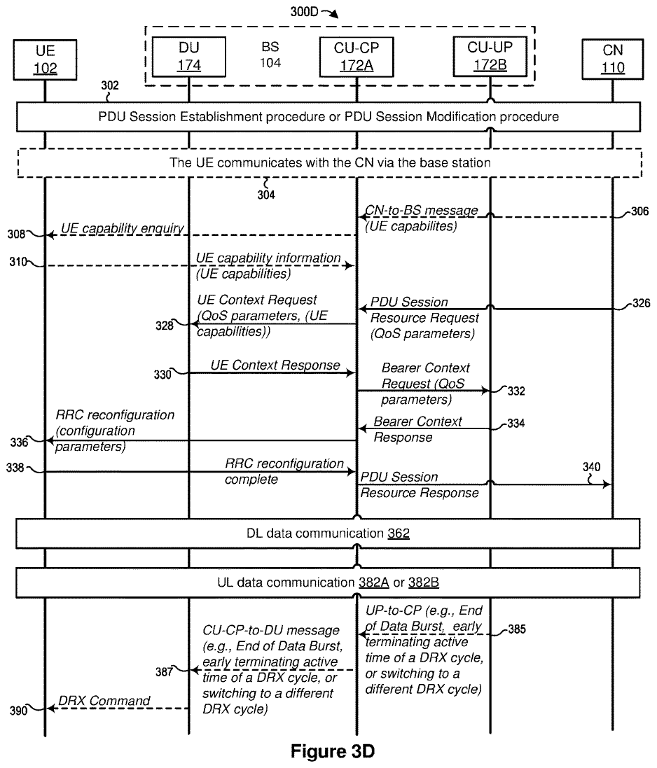

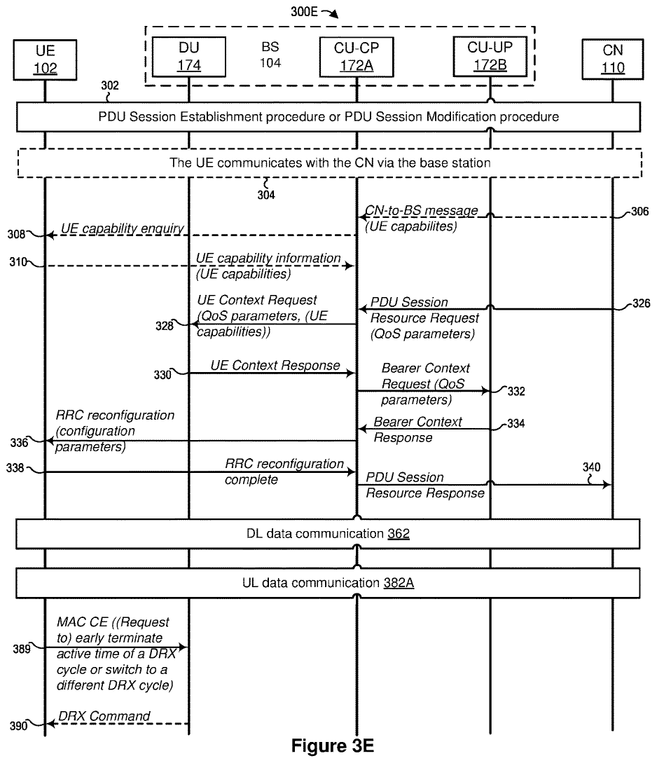

Next, several example scenarios in which the base station operating in the system of FIG. 1A and FIG. 1B communicates data with the UE 102, as well as several example methods that can be implemented in a RAN node or a UE, are considered with reference to FIGS. 3A-16B.

Generally speaking, similar events in FIGS. 3A-16B are labeled with the similar reference numbers that share two least significant digits, with differences discussed below where appropriate. For example, event 302 is similar to block 402, block 1502 is similar to block 1602, etc. With the exception of the differences shown in the figures and discussed below, any of the alternative implementations discussed with respect to a particular event (e.g., for messaging and processing) may apply to events labeled with similar reference numbers in other figures.

Referring first to FIG. 3A, in a scenario 300A, the base station 104 includes a CU-CP 172A, a CU-UP 172B and a DU 174. Initially, the UE 102 performs 302 a PDU Session Establishment procedure or a PDU Session Modification procedure with the CN 110 via the base station 104 (e.g., CU-CP 172A and DU 174) or the base station 106 (not shown in FIG. 3) to establish or modify a PDU session for performing one or more services. In some implementations, the service(s) such as XR services and/or cloud games require high-data-rate and low-latency transmissions. In some implementations, the UE 102 performs 302 the PDU Session Establishment procedure or the PDU Session Modification procedure with the SMF 166 via the AMF 164 and the base station 104 or 106.

During the PDU Session Establishment procedure, the UE 102 transmits a PDU Session Establishment Request message to the CN 110 via the base station (e.g., the base station 104 or 106). In response, the CN 110 can send a PDU Session Establishment Accept message to the CN 110 via the base station. In response to the PDU Session Establishment Accept message, the UE 102 then transmits a PDU Session Establishment Complete message to the CN 110 via the base station. In the PDU Session Modification procedure, the UE 102 transmits a PDU Session Modification Request message to the CN 110 via the base station. In response, the CN 110 can send a PDU Session Modification Command message to the CN 110 via the base station. In response to the PDU Session Modification Command message, the UE 102 then transmits a PDU Session Modification Complete message to the CN 110 via the base station.

In some implementations, the UE 102 can include, in the PDU Session Establishment Request message or PDU Session Modification Request message, a PDU session ID identifying the PDU session, slice information, and/or a particular data network name (DNN). In some implementations, the CN 110 may include the PDU session ID in the PDU Session Establishment Accept message or PDU Session Modification Command message to indicate that the PDU session is established or modified successfully. In some implementations, the slice information indicate a specific slice configured for the service(s). For example, the slice information can be a Single Network Slice Selection Assistance Information (S-NSSAI) or includes a portion of the S-NSSAI. In other implementations, the UE 102 can include, in the PDU Session Establishment Request message or PDU Session Modification Request message, UE-requested quality of service (QOS) parameters that the UE 102 requires to perform the service(s).

After performing the procedure 302, the UE 102 communicates 304 with the CN 110 via the base station 104 (e.g., the CU-CP 172A, CU-UP 172B and DU 174). Before, during or after the procedure 302 or while communicating with the UE 102, the CU-CP 172A might receive 306 a CN-to-BS message including UE capabilities of the UE 102 from the CN 110. For example, the CN-to-BS message is a next generation application protocol (NGAP) message. In another example, the CN-to-BS message is an interface message for 6G. The CU-CP 172A may transmit a CU-to-DU message including the UE capabilities to the DU 174. The CU-to-DU message may be a F1 Application Protocol (F1AP) message, a UE Context Setup Request message or a UE Context Modification Request message. Alternatively, the CU-CP 172A transmits 308 a UE capability enquiry message to the UE 102 via the DU 174 to enquiry the UE capabilities. In response, the UE 102 transmits 310 a UE capability information message including the UE capabilities to the CU-CP 172A via the DU 174. In some implementations, the UE capabilities include (new) capabilities indicating support of one or more functions/features for enhancing communication of data requiring high data rate and low latency, such as XR data or cloud gaming data. For example, the function(s)/feature(s) include multiple configured grant (CG) Physical Uplink Shared Channel (PUSCH) transmission occasions in a period of a single CG configuration, dynamic indication of unused CG PUSCH occasion(s) using UL control information (UCI), buffer status reporting (BSR) enhancements including at least new buffer status table(s), delay reporting of buffered data in uplink, provision of XR traffic assistance information for DL and UL (e.g. periodicity) and/or PDU Set based QoS handling (e.g., discard operation of PDU Set(s)). A PDU Set includes one or more PDUs carrying a payload of one unit of information generated at the application level (e.g. frame(s) or video slice(s) etc. for a XR services).

During or after the procedure 302 or during the communication 304, the CN 110 transmits 326 a PDU Session Resource Request message to the CU-CP 172A to request the CU-CP 172A to assign resources for the PDU session and one or more QoS flows for the UE 102. The QoS flow(s) is/are associated with the PDU session. In some implementations, the CN 110 can include a first set of PDU Set QoS parameters for the PDU session or the QoS flow(s) in the PDU Session Resource Request message. In one implementation, the CN 110 includes a first set of PDU Set QoS parameters to request or configure PDU Set based QoS handling for the PDU session or the QoS flow(s). After (e.g., in response to) receiving the PDU Session Resource Request message, the CU-CP 172A transmits 328 a UE Context Request message for the PDU session or QoS flow(s) to the DU 174. In some implementations, the CU-CP 172A includes a second set of PDU Set QoS parameters in the UE Context Request message to request or configure PDU Set based QoS handling for the PDU session or the QoS flow(s). In some implementations, the second set of PDU Set QoS parameters is the same as or identical to the first set of PDU Set QoS parameters. In other implementations, the second set of PDU Set QoS parameters is different from the first set of PDU Set QoS parameters. In some implementations, the CU-CP 172A determines the second set of PDU Set QoS parameters based on the first set of PDU Set QOS parameters. In such cases, the CU-CP 172A ensures that the second set of PDU Set QoS parameters satisfies the first set of PDU Set QoS parameters. For example, the CU-CP 172A might determine the second set of PDU Set QoS parameters more stringent than the first set of PDU Set QoS parameters, considering latency in a F1-U connection between the CU-UP 172B and DU 174, data processing time at the CU-UP 172B, and/or data processing time at the DU 174.

In some implementations, the CU-CP 172A determines to include or includes the second set of PDU Set QoS parameters in the UE Context Request message, if the CU-CP 172A, the CU-UP 172B and/or DU 174 support(s) PDU Set based QoS handling. If the CU-CP 172A, CU-UP 172B and/or DU 174 do/does not support PDU Set based QoS handling, the CU-CP 172A does not include PDU Set QoS parameters (e.g., the second set of PDU Set QoS parameters) in the UE Context Request message. In other implementations, the CU-CP 172A determines to include or includes the second set of PDU Set QoS parameters in response to receiving at least one of the (new) capabilities. If the UE capabilities do not include the (new) capability/capabilities, the CU-CP 172A might not include the second set of PDU Set QoS parameters in the UE Context Request message.

In some implementations, the CN 110 can include a (corresponding) set of PDU Set QOS parameters for each of the QoS flow(s) indicated in the PDU Session Resource Request message. In such cases, the CU-CP 172A might include a (corresponding) set of PDU Set QoS parameters in the UE Context Request message. In some implementations, for each of the QoS flow(s), the corresponding set of PDU Set QoS parameters in the UE Context Request message is the same as or identical to the corresponding set of PDU Set QoS parameters in the PDU Session Resource Request message. In other implementations, for each of the QoS flow(s), the CU-CP 172A determines the corresponding set of PDU Set QoS parameters in the UE Context Request message based on the corresponding set of PDU Set QoS parameters in the PDU Session Resource Request message.

In some implementations, the CN 110 might include, in the PDU Session Resource Request message, a first set of non-PDU Set QoS parameters (i.e., QoS parameter(s) not related to a PDU Set). In such cases, the CU-CP 172A might include a second set of non-PDU Set QoS parameters in the UE Context Request message. In some implementations, the second set of non-PDU Set QoS parameters is the same as or identical to the first set of non-PDU Set QoS parameters. In other implementations, the CU-CP 172A determines the second set of non-PDU Set QoS based on the first set of non-PDU Set QoS parameters. In some implementations, the CN 110 includes a (corresponding) set of non-PDU Set QOS parameter(s) for each of the QoS flow(s) in the PDU Session Resource Request message. In such cases, the CU-CP 172A might include a (corresponding) set of non-PDU Set QoS parameters for each of the QoS flow(s) in the UE Context Request message. In some implementations, for each of the QoS flow(s), the corresponding set of non-PDU Set QoS parameters in the UE Context Request message is the same as or identical to the corresponding set of non-PDU Set QoS parameters in the PDU Session Resource Request message. In other implementations, for each of the QoS flow(s), the CU-CP 172A determines the corresponding set of non-PDU Set QoS parameters in the UE Context Request message based on the corresponding set of non-PDU Set QoS parameters in the PDU Session Resource Request message. In other implementations, the CN 110 does not include, in the PDU Session Resource Request message, non-PDU Set QoS parameters for the PDU session or QoS flow(s). In such cases, the CU-CP 172A might not include, in the UE Context Request message, non-PDU Set QoS parameters for the PDU session or QoS flow(s).

In some implementations, (a set of) non-PDU Set QoS parameters (described above) include(s) a QoS identifier descriptor, a maximum flow bit rate for DL, a maximum flow bit rate for UL, a guaranteed flow bit rate for DL, and/or a guaranteed flow bit rate for UL.

In some implementations, the CN 110 includes a PDU Session ID identifying the PDU session in the PDU Session Resource Request message. In some implementations, the CN 110 includes one or more QoS flow identifiers identifying the QoS flow(s) in the PDU Session Resource Request message. Each of the QoS flow identifier(s) identifies a particular QoS flow of the QoS flow(s). In some implementations, the CU-CP 172A includes the QOS flow identifier(s) in the UE Context Request message and associate (each of) the QoS flow identifier(s) with the (corresponding) set of the PDU Set QoS parameters and/or non-PDU Set QoS parameters.

In response to receiving 328 the UE Context Request message, the DU 174 transmits 330 a UE Context Response message to the CU-CP 172A. In some implementations, the DU 174 assigns resources for the PDU Session or QoS flow(s), generates DU configuration parameters for communicating data associated with the PDU session or QoS flow(s), and includes the DU configuration parameters in the UE Context Response message. In some implementations, the DU 174 includes DL transport layer information in the UE Context Response message. In one implementation, the DL transport layer information configures a tunnel (e.g., GTP-U tunnel) for the CU-UP 172B to transmit DL PDUs for the UE 102 to the DU 174 in the DL data communication (e.g., events 352, 358).

In some implementations, if the DU 174 supports PDU Set based QoS handling or the second set of PDU Set QoS parameters, the DU 174 includes, in the UE Context Response message, confirmation information (explicitly) indicating that the DU 174 applies (e.g., performs) PDU Set based QoS handling (e.g., for the PDU session or QoS flow(s)), based on the second set of PDU Set QoS parameters. In other implementations, if the DU 174 does not support PDU Set based QoS handling or the second set of PDU Set QoS parameters, the DU 174 includes unsupported information (e.g., a cause (value)) in the UE Context Response message to indicate that the DU 174 does not support PDU Set based QoS handling or the second set of PDU Set QoS parameters. In some alternative implementations, the DU 174 implicitly indicates that the DU 174 supports PDU Set based QoS handling or the second set of PDU Set QoS parameters, by excluding the unsupported information in the UE Context Response message.

In some implementations, if the DU 174 supports the second set of PDU Set QoS parameters or PDU Set based QoS handling, the DU 174 assigns resources for the PDU Session or QOS flow(s) and/or generates some or all of the configuration parameters, based on the second set of PDU Set QoS parameters. In some implementations, if the UE 102 and/or DU 174 support(s) the second set of PDU Set QoS parameters or PDU Set based QoS handling, the DU 174 might enable PDU Set based QoS handling (e.g., for the PDU session or QoS flow(s)). In one implementation, the DU 174 enables PDU Set based QoS handling after (e.g., in response to) receiving the second set of PDU Set QoS parameters or the UE Context Request message. In another implementation, the DU 174 enables PDU Set based QoS handling (e.g., for the PDU session or QoS flow(s)), regardless of whether or before receiving the second set of PDU Set QoS parameters or the UE Context Request message.

In some implementations, if the UE 102 and/or DU 174 support(s) PDU Set based QoS handling and/or the UE Context Request message includes PDU Set QoS parameters (e.g., the second set of PDU Set QoS parameters), the DU 174 might include, in the DU configuration parameters, at least one configuration parameter for PDU Set based QoS handling. In some implementations, the DU 174 might additionally take the second set of non-PDU Set QoS parameters into account when configuring the configuration parameters and/or assigning resources for the UE 102. In other implementations, the DU 174 ignores the second set of non-PDU Set QoS parameters when configuring the configuration parameters and/or assigning resources for the UE 102. By properly assigning resources for the UE 102 and/or configuring the configuration parameters, the DU 174 ensures that data associated with the PDU session or QoS flow(s) is communicated with the UE 102 in compliance with the second set of PDU Set QoS parameters and/or the second set of non-PDU Set QoS parameters in the DL data communication (e.g., events 354, 360) and/or UL data communication (e.g., events 370, 376A). In some implementations, if the UE 102 and/or DU 174 support(s) PDU Set based QoS handling and/or the UE Context Request message includes PDU Set QoS parameters (e.g., the second set of PDU Set QoS parameters), the DU 174 configures the at least one configuration parameter. Otherwise, if the UE 102 and/or DU 174 do(es) not support PDU Set based QoS handling and/or the UE Context Request message does not include PDU Set QOS parameters, the DU 174 not include the at least one configuration parameter in the configuration parameters 330. In this case, the UE 102 does not enable or disables PDU Set based QoS handling in response to receiving the configuration parameters excluding the at least one configuration parameter.

In other implementations, if the UE 102 and/or DU 174 do(es) not support the second set of PDU Set QoS parameters or PDU Set based QoS handling, the DU 174 assigns resources for the PDU Session or QoS flow(s) and/or generates the configuration parameters, based on the second set of non-PDU Set QoS parameters. If the UE 102 and/or DU 174 do(es) not support the second set of PDU Set QoS parameters or PDU Set based QoS handling and the UE Context Request message does not include non-PDU Set QoS parameters, the DU 174 assigns resources for the PDU Session or QoS flow(s) and/or generates the configuration parameters, based on predefined QoS parameters. In such implementations, the configuration parameters exclude the at least one configuration parameter for PDU Set based QoS handling. By properly assigning resources and/or configuring the configuration parameters for the UE 102, the DU 174 ensures that data associated with the PDU session or QoS flow(s) is communicated with the UE 102 in compliance with the second set of non-PDU Set QoS parameters or predefined QoS parameters in the DL data communication (e.g., events 354, 360) and/or UL data communication (e.g., events 370, 376A).

In some implementations, the CU-CP 172A includes the UE capabilities in the UE Context Request message 328. In other implementations, the CU-CP 172A transmits another CU-to-DU message including the UE capabilities to the DU 174. In response, the DU transmits a DU-to-CU message to the CU-CP 172A. The CU-to-DU message and DU-to-CU message might be a UE Context Setup Request message and a UE Context Setup Response message, respectively. Thus, the DU 174 can determine whether the UE 102 supports PDU Set based QoS handling based on the UE capabilities.

The UE Context Request message and UE Context Response message form a UE Context procedure (e.g., a UE Context Setup procedure or a UE Context Modification procedure). In some implementations, the UE Context Request message and the UE Context Response message are a UE Context Setup Request message and a UE Context Setup Response message, respectively. In other implementations, the UE Context Request message and the UE Context Response message are a UE Context Modification Request message and a UE Context Modification Response message, respectively. In some alternative implementations, the DU 174 includes the configuration parameters in a UE Context Modification Required message instead of the UE Context Response message and transmits the UE Context Modification Required message to the CU-CP 172A. In this case, the CU-CP 172A may transmit a UE Context Modification Confirm message to the DU 174 in response to the UE Context Modification Required message.

After receiving 326 the PDU Session Resource Request message, transmitting 328 the UE Context Request message or receiving 330 UE Context Response message, the CU-CP 172A performs a Bearer Context procedure with the CU-UP 172B to establish or modify a bearer context for the UE 102. In the Bearer Context procedure, the CU-CP 172A transmits 332 a Bearer Context Request message for the UE 102 (e.g., for the PDU session or QoS flow(s)) to the CU-UP 172B and in response, the CU-UP 172B transmits 334 a Bearer Context Response message to the CU-CP 172A. In some implementations, the CU-UP 172B might include UL transport layer information in the Bearer Context Response message. The UL transport layer information may configure a tunnel (e.g., GTP-U tunnel) for the DU 174 to transmit UL PDUs received from the UE 102 to the CU-UP 172B in the UL data communication (e.g., events 372, 378A). The CU-CP 172A then includes the UL transport layer information in the UE Context Request message 328. After receiving 330 UE Context Response message, the CU-CP 172A might perform a Bearer Context Modification procedure with the CU-UP 172B to provide the DL transport layer information received in the UE Context Response message. In the Bearer Context Modification procedure, the CU-CP 172A transmits a Bearer Context Modification Request message including the DL transport layer information to the CU-UP 172B and in response, the CU-UP 172B transmits a Bearer Context Modification Response message.

In some implementations, the Bearer Context procedure is a Bearer Context Setup procedure, and the Bearer Context Request message and the Bearer Context Response message are a Bearer Context Set Request message and a Bearer Context Setup Response message, respectively. In other implementations, the Bearer Context procedure is a Bearer Context Modification procedure, and the Bearer Context Request message and the Bearer Context Response message are a Bearer Context Modification Request message and a Bearer Context Modification Response message, respectively. In such cases, the CU-CP 172A might include the DL transport layer information in the Bearer Context Modification Request message.

In some implementations, the CU-CP 172A might include a third set of PDU Set QoS parameters for the UE 102 (e.g., for the PDU session or QoS flow(s)) in the Bearer Context Request message to request or configure PDU Set based QoS handling for the PDU session or QOS flow(s). In some implementations, the third set of PDU Set QoS parameters is the same as or identical to the first or second set of PDU Set QoS parameters. In other implementations, the third set of PDU Set QoS parameters is different from the first set of PDU Set QoS parameters and/or the second set of PDU Set QoS parameters. In some implementations, the CU-CP 172A determines the third set of PDU Set QoS parameters based on the first set of PDU Set QoS parameters. In such cases, the CU-CP 172A ensures that the third set of PDU Set QoS parameters satisfies the first set of PDU Set QoS parameters. For example, the CU-CP 172A might determine the third set of PDU Set QoS parameters more stringent than the first set of PDU Set QoS parameters, considering latency in a F1-U connection between the CU-UP 172B and DU 174, data processing time at the CU-UP 172B, and/or data processing time at the DU 174. In some implementations, the third set of PDU Set QoS parameters are the same as the second set of PDU Set QoS parameters.

In some implementations, the CU-CP 172A determines to include or includes the third set of PDU Set QoS parameters in the Bearer Context Request message, if the CU-CP 172A and/or CU-UP 172B support(s) PDU Set based QoS handling. If the CU-CP 172A and/or CU-UP 172B do/does not support PDU Set based QoS handling, the CU-CP 172A does not include PDU Set QoS parameters (e.g., the third set of PDU Set QoS parameters) in the Bearer Context Request message. In other implementations, the CU-CP 172A determines to include or includes the third set of PDU Set QoS parameters in the Bearer Context Request message, in response to receiving at least one of the (new) capabilities. If the UE capabilities do not include the (new) capability/capabilities, the CU-CP 172A might not include the third set of PDU Set QoS parameters in the Bearer Context Request message.

In these cases where the CN 110 can include a (corresponding) set of PDU Set QoS parameters for each of the QoS flow(s) indicated in the PDU Session Resource Request message, the CU-CP 172A might include a (corresponding) set of PDU Set QoS parameters in the Bearer Context Request message. In some implementations, for each of the QoS flow(s), the corresponding set of PDU Set QoS parameters in the Bearer Context Request message is the same as or identical to the corresponding set of PDU Set QoS parameters in the PDU Session Resource Request message. In other implementations, for each of the QoS flow(s), the CU-CP 172A determines the corresponding set of PDU Set QOS parameters in the Bearer Context Request message, based on the corresponding set of PDU Set QoS parameters in the PDU Session Resource Request message, similar to determining the third set of PDU Set QoS parameters as described above.

In these cases where the CN 110 might include, in the PDU Session Resource Request message, the first set of non-PDU Set QoS parameters (i.e., QoS parameter(s) not related to a PDU Set), the CU-CP 172A might include a third set of non-PDU Set QoS parameters in the Bearer Context Request message. In some implementations, the third set of non-PDU Set QoS parameters is the same as or identical to the first set of non-PDU Set QoS parameters. In other implementations, the CU 172 determines the third set of non-PDU Set QoS based on the first set of non-PDU Set QoS parameters. In some implementations, the CN 110 includes a (corresponding) set of non-PDU Set QoS parameter(s) for each of the QoS flow(s) in the PDU Session Resource Request message. In such cases, the CU 172 might include a (corresponding) set of non-PDU Set QoS parameters for each of the QoS flow(s) in the Bearer Context Request message. In some implementations, for each of the QoS flow(s), the corresponding set of non-PDU Set QoS parameters in the Bearer Context Request message is the same as or identical to the corresponding set of non-PDU Set QoS parameters in the PDU Session Resource Request message. In other implementations, for each of the QoS flow(s), the CU-CP 172A determines the corresponding set of non-PDU Set QoS parameters in the Bearer Context Request message based on the corresponding set of non-PDU Set QoS parameters in the PDU Session Resource Request message. In other implementations, the CN 110 does not include, in the PDU Session Resource Request message, non-PDU Set QoS parameters for the PDU session or QoS flow(s). In such cases, the CU 172 might not include, in the Bearer Context Request message, non-PDU Set QoS parameters for the PDU session or QoS flow(s).

In some implementations, (a set of) non-PDU Set QoS parameters (described above) include(s) a QoS identifier descriptor, a maximum flow bit rate for DL, a maximum flow bit rate for UL, a guaranteed flow bit rate for DL, and/or a guaranteed flow bit rate for UL. In some implementations, the CU-CP 172A includes the QoS flow identifier(s) in the Bearer Context Request message and associate (each of) the QoS flow identifier(s) with the (corresponding) set of the PDU Set QoS parameters and/or non-PDU Set QoS parameters. In some implementations, the CU-CP 172A includes the PDU Session ID in the Bearer Context Request message.

In some implementations, the CU-UP 172B assigns resources for the PDU Session or QoS flow(s) in accordance with the Bearer Context Request message. In some implementations, the CU-UP 172B applies one or more configurations in the Bearer Context Request message to communicate data with the DU 174 and UE 102, where the data is associated with the PDU session or QoS flow(s). In some implementations, if the CU-UP 172B supports PDU Set based QoS handling or the third set of PDU Set QoS parameters, the CU-UP 172B includes, in the Bearer Context Response message, confirmation information (explicitly) indicating that the CU-UP 172B applies (e.g., performs) PDU Set based QoS handling based on the third set of PDU Set QOS parameters. In other implementations, if the CU-UP 172B does not support PDU Set based QoS handling or the third set of PDU Set QoS parameters, the CU-UP 172B includes unsupported information (e.g., a cause (value)) in the Bearer Context Response message to indicate that the CU-UP 172B does not support PDU Set based QoS handling or the third set of PDU Set QoS parameters. In some alternative implementations, the CU-UP 172B implicitly indicates that the CU-UP 172B supports PDU Set based QoS handling or the third set of PDU Set QOS parameters, by excluding the unsupported information in the Bearer Context Response message.

In some implementations, if the CU-UP 172B supports the third set of PDU Set QoS parameters or PDU Set based QoS handling, the CU-UP 172B assigns resources for the PDU session or QoS flow(s), based on the third set of PDU Set QoS parameters. In some implementations, if the CU-UP 172B supports the third set of PDU Set QoS parameters or PDU Set based QoS handling, the CU-UP 172B might enable PDU Set based QoS handling. In some implementations, the CU-UP 172B enables PDU Set based QoS handling for the UE 102 (e.g., for the PDU session or QoS flow(s)), after (e.g., in response to) receiving the third set of PDU Set QoS parameters or the Bearer Context Request message. In other implementations, the CU-UP 172B enables PDU Set based QoS handling, regardless of whether or before receiving the third set of PDU Set QoS parameters or the Bearer Context Request message. In some implementations, the CU-UP 172B might additionally take the third set of non-PDU Set QoS parameters into account when configuring the configuration parameters and/or assigning resources for the UE 102. In other implementations, the CU-UP 172B ignores the third set of non-PDU Set QoS parameters. By properly assigning resources for the UE 102 and/or configuring the configuration parameters, the CU-UP 172B ensures that data associated with the PDU session or QoS flow(s) is communicated with the DU 174 and/or the UE 102 in compliance with the (third/corresponding set of) PDU Set QoS parameters and/or (third/corresponding set of) non-PDU Set QoS parameters in the DL data communication (e.g., events 352, 358) and/or UL data communication (e.g., events 372, 378A).

In other implementations, if the CU-UP 172B does not support the third set of PDU Set QOS parameters or PDU Set based QoS handling, the CU-UP 172B assigns resources for the PDU Session or QoS flow(s), based on the third set of non-PDU Set QoS parameters. If the CU-UP 172B does not support the third set of PDU Set QoS parameters or PDU Set based QoS handling and the Bearer Context Request message does not include non-PDU Set QoS parameters, the CU-UP 172B assigns resources for the PDU Session or QoS flow(s), based on predefined QoS parameters (e.g., non-PDU Set QoS parameters). By properly assigning resources for the UE 102, the CU-UP 172B ensures that data associated with the PDU session or QoS flow(s) is communicated with the DU 174 and/or the UE 102 in compliance with the third set of non-PDU Set QoS parameters, the predefined QoS parameters in the DL data communication (e.g., events 352, 358) and/or UL data communication (e.g., events 372, 378A).

In some implementations, (each of) the (first, second and/or third) set(s) of PDU Set QoS parameters include(s) PDU Set Delay Budget (PSDB), PDU Set Error Rate (PSER), and/or PDU Set Integrated Handling Information (PSIHI). The PSDB may define an upper bound for a delay time that a PDU Set may experience for the transfer between the UE 102 and the CN 110 (e.g., the UPF 162). For DL, the delay time may be a time duration between the reception time of the first PDU of a DL PDU Set at the CN 110 (e.g., the UPF 162) and the time when all PDUs of the DL PDU Set have been successfully received at the UE. For UL, the delay time may be a time duration between the reception time of the first PDU of a UL PDU Set at the UE 102 (e.g., the reception time where a protocol layer of the UE 102 receives the first PDU from an application) and the time when all PDUs of the UL PDU Set have been successfully received at the CN 110 (e.g., the UPF 162). The protocol layer can be the SDAP 212, PDCP 210, RLC 206 or MAC 204). In some implementations, the application can be an operating system (e.g., Android, IOS, Windows or Linux). In some implementations, the PSDB applies to a DL PDU Set for the UE 102 received by the CN 110 (e.g., the UPF 162), and applies to the UL PDU Set sent by the UE 102. The PSER defines an upper bound for a rate of PDU Sets that have been processed by a sender (e.g., the UE 102, CU 172 or DU 174) of a link layer protocol (e.g., RLC 206) but that are not successfully delivered by a corresponding receiver to an upper layer (e.g., PDCP 210) of the receiver. Thus, the PSER defines an upper bound for a rate of non-congestion related PDU Set losses. The purpose of the PSER is to allow for appropriate link layer protocol configurations (e.g. PDCP configuration, RLC bearer configuration, MAC configuration and/or HARQ configuration) in the configuration parameters. The PSIHI indicates whether all PDUs (e.g., data packets) of a PDU Set are needed for the usage of the PDU Set by the application layer in a receiver. If the PDU Set is a DL PDU Set, the receiver is the UE 102. If the PDU Set is a UL PDU Set, the receiver is the DU 174, CU-UP 172B or CN 110. In some implementations, the CU-UP 172B or DU 174 might determine whether to discard a PDU Set associated with the PDU session or QoS flow(s), based on the PSIHI and PSDB. For example, if the CU-UP 172B or DU 174 determines that transmission of a PDU Set exceeds the PSDB and the PSIHI indicates that all PDUs of a PDU Set are needed for the usage of the PDU Set by the application layer in the UE 102, the CU-UP 172B or DU 174 might discard the PDU Set. Otherwise, the CU-UP 172B or DU 174 does not discard the PDU Set and transmits the PDU Set to the DU 174 or UE 102.

After (e.g., in response to) receiving the UE Context Response message or UE Context Modification Required message, the CU-CP 172A transmits 336 a RRC reconfiguration message to the UE 102 via the DU 174. In response, the UE 102 transmits 338 a RRC reconfiguration complete message to the CU-CP 172A via the DU 174. If the CU-CP 172A receives the DU configuration parameters, the CU-CP 172A includes the DU configuration parameters in the RRC reconfiguration message. In some implementations, if the UE 102 and/or base station 104 (e.g., the CU-CP 172A, CU-UP 172B and/or DU 174) support(s) PDU Set based QoS handling and/or the PDU Session Resource Request message includes PDU Set QoS parameters (e.g., the first set of PDU Set QoS parameters), the CU-CP 172A might include at least one configuration for PDU Set based QoS handling in the RRC reconfiguration message. In some implementations, the UE 102 enables PDU Set based QoS handling, in response to receiving the RRC reconfiguration message, configuration(s) for PDU Set based QoS handling, and/or the configuration parameters(s) in the DU configuration parameters. Otherwise, if the UE 102 and/or base station 104 do(es) not support PDU Set based QoS handling and/or the PDU Session Resource Request message does not include PDU Set QOS parameters, the CU-CP 172A does not include configuration parameter(s) for PDU Set based QoS handling in the RRC reconfiguration message. Thus, the UE 102 refrains from enabling or disables PDU Set based QoS handling in response to receiving the RRC reconfiguration message.

In some implementations, the CU-CP 172A includes a measurement configuration and/or one or more DRB configurations in the RRC reconfiguration message. The measurement configuration configure the UE 102 to measure a reference signal on a carrier frequency and report measurement results that the UE obtains from the measurement of the reference signal. The DRB configuration(s) configure one or more DRBs associated with the PDU session and/or QOS flow(s). Each of the DRB configuration(s) might include a PDCP configuration and/or a SDAP configuration. In some implementations, the CU-CP 172A includes the configuration parameter(s) for PDU Set based QoS handling in the DRB configuration(s), PDCP configuration(s) and/or SDAP configuration(s). In some implementations, the DU configuration parameters include one or more RLC bearer configurations each configuring a RLC bearer for a particular DRB, and/or include MAC configuration parameters and/or physical layer configuration parameters. In some implementations, the CU-CP 172A determines or configures the PDCP configuration(s) and/or SDAP configuration(s), based on the first set of PDU Set QoS parameters, second set of PDU Set QoS parameters or third set of PDU Set QoS parameters.

Before or after receiving the UE Context Response message or receiving the RRC reconfiguration complete message, the CU-CP 172A transmits 340 a PDU Session Resource Response message to the CN 110 in response to receiving the PDU Session Resource Request message. In some implementations, if the base station 104 support PDU Set based QoS handling as described above, the CU-CP 172A includes, in the PDU Session Resource Response message, confirmation information indicating that the base station 104 applies (e.g., performs) PDU Set based QoS handling based on the first set of PDU Set QoS parameters. In other implementations, if the base station 104 does not support PDU Set based QoS handling (e.g., based on the first set of PDU Set QoS parameters), the CU-CP 172A includes unsupported information (e.g., a cause (value)) in the PDU Session Resource Response message to indicate that the base station 104 does not support PDU Set based QoS handling or the first set of PDU Set QoS parameters. In some alternative implementations, if the base station 104 supports PDU Set based QoS handling as described above, the CU-CP 172A implicitly indicates that the base station 104 supports the first set of PDU Set QoS parameters or PDU Set based QoS handling, by excluding the unsupported information in the PDU Session Resource Response message.

In some implementations, the PDU Session Resource Request message and the PDU Session Resource Response message are a PDU Session Resource Setup Request message and a PDU Session Resource Setup Response message, respectively. In other implementations, the PDU Session Resource Request message and the PDU Session Resource Response message are a PDU Session Resource Modify Request message and a PDU Session Resource Modify Response message, respectively.

After receiving the PDU Session Resource Response message, the CN 110 (e.g., the UPF 162) transmits DL data packets 1, . . . , N associated with the PDU session or QOS flow(s) to the UE 102 via the CU-UP 172B and DU 174. N is an integer and larger than zero. In some implementations, the CN 110 receives the DL data packets 1, . . . , N from a packet data network (e.g., a cloud server or an application server). The CN 110 generates CN-to-CU-UP packets 1, . . . , N including the DL data packets 1, . . . , N, respectively. Each of the CN-to-CU-UP packets 1, . . . , N includes one or more protocol headers. The CN 110 transmit 350, 356 the CN-to-CU-UP packets 1, . . . , N to the CU-UP 172B. In some implementations, the CN-to-CU-UP packet are General Packet Radio System (GPRS) Tunneling Protocol User Plane (GTP-U) packets. The protocol header(s) include an Internet Protocol (IP) header, a User Datagram Protocol (UDP) header, and/or a GTP-U header. The CU-UP 172B retrieves the DL data packets 1, . . . , N from the CN-to-CU-UP packets 1, . . . , N, generates DL PDUs 1, . . . , N including the DL data packets 1, . . . , N, and transmits 352, 358 the CU-UP-to-DU packets 1, . . . , N to the DU 174, respectively. Each of the CU-UP-to-DU packets 1, . . . , N includes one or more protocol headers. In some implementations, the CU-UP-to-DU packets are GTP-U packets. The protocol header(s) include an IP header, a UDP header, and/or a GTP-U header. The DU 174 retrieves the DL PDUs 1, . . . , N from the CU-UP-to-DU packets, respectively. The DU 174 transmits 354, 360 the DL PDU 1, . . . , N to the UE 102 via protocols e.g., NR RLC 206B, NR MAC 204B and NR PHY 202B). The transmission is based on the configuration parameters 336 and uses resources that are assigned to the UE 102.

In some implementations, the DL data packets 1, . . . , N belong to a data burst and the DL data packet N is the last data packet of the data burst. In some implementations, the CN 110 includes an end indication indicating the end of the data burst (i.e., the data burst ends) in the CN-to-CU-UP packet N and does not include the end indication in the CN-to-CU-UP packets 1, . . . , N−1. In other words, the end indication indicates that the DL data packet N is the last packet of the data burst. When receiving the CN-to-CU-UP packet N, the CU-UP 172B retrieves the end indication from the CN-to-CU-UP packet N and includes, in the CU-UP-to-DU packet N, an end indication indicating the DL data packet N is the last packet of the data burst, accordingly. The CU-UP 172B does not include the end indication in the CU-UP-to-DU packets 1, . . . , N−1. In other words, the end indication indicates the end of the data burst. In some implementations, a header (e.g., GTP-U header) of a CN-to-CU-UP packet (e.g., the CN-to-CU-UP packet 1, . . . , N) includes a field indicating whether a DL data packet included in the CN-to-CU-UP packet is the last packet of a data burst. For example, the field has two values. A first value of the field indicates the included DL data packet is the last packet of a data burst, and a second value of the field indicates the included DL data packet is not the last packet of a data burst. In some implementations, a header (e.g., GTP-U header) of a CU-UP-to-DU packet (e.g., the CU-UP-to-DU packet 1, . . . , N) includes a field indicating whether a DL data packet included in the CU-UP-to-DU packet is the last packet of a data burst. For example, the field has two values. A third value of the field indicates the included DL data packet is the last packet of a data burst, and a fourth value of the field indicates the included DL data packet is not the last packet of a data burst. In such implementations, the CN 110 sets the field in the CN-to-CU-UP packet N to the first value and sets the field in the CN-to-CU-UP packets 1, . . . , N−1 to the second value, and the CU-UP 172B sets the field in the CU-UP-to-DU packet N to the third and sets the field in the CU-UP-to-DU packets 1, . . . , N−1 to the fourth value. Depending on implementations, the third value can be the same as or different from the first value, and the fourth value can be the same as or different from the second value. In other implementations, the CU-UP 172B does not include the end indication in the CU-UP-to-DU packet N or does not include the field in the CU-UP-to-DU packets 1, . . . , N.

While the UE 102 communicates with the DU 174 (e.g., in events 336, 338, 354 and/or 360), the UE 102 performs discontinuous reception (DRX) periodically with DU 174 in accordance with a DRX configuration. The DRX configuration configures a first DRX cycle consisting of a start offset, an on duration, an off duration and/or a DRX cycle length and the first DRX cycle periodically occurs. In some implementations, the UE 102 receives the DRX configuration in a message from the base station 104 or base station 106. For example, the message is the RRC reconfiguration message 336 or another RRC reconfiguration message. In another example, the message is a RRC resume message. In some implementations, after receiving the end indication 358, the DU 174 transmits 390 a DRX command to the UE 102. In some implementations, the DU 174 transmits 390 a DL MAC PDU including the DRX command to the UE 102. In some implementations, the DRX command is a MAC subheader including a specific logical channel ID. In other implementations, the DRX command is a MAC control element (CE). The DU 174 might include a MAC subheader for the MAC CE in the DL MAC PDU.

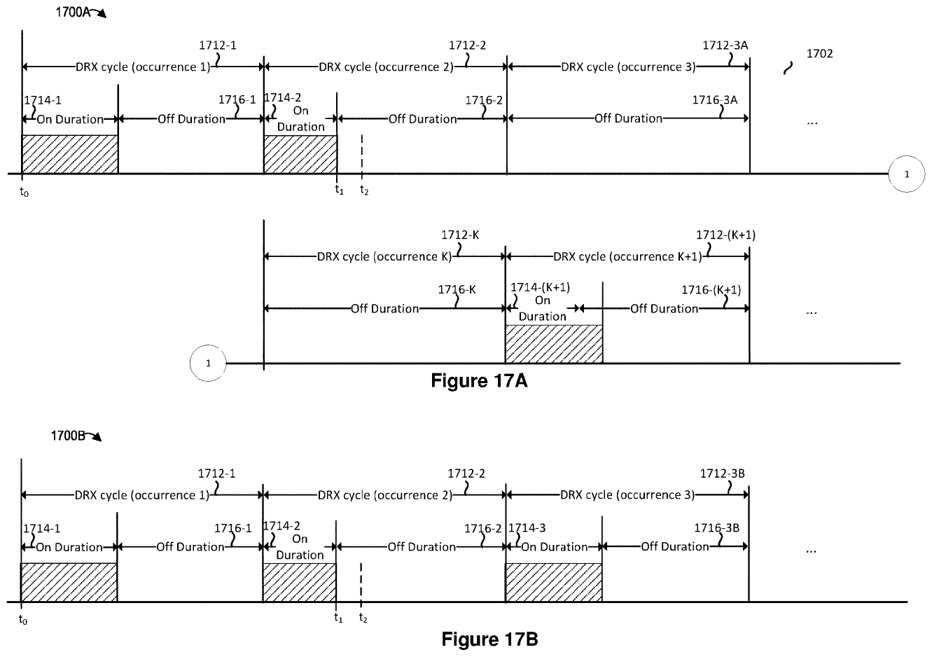

In some implementations, the DRX command orders the UE 102 to early terminate active time (e.g., an on duration) of at least one consecutive occurrence (or instance) of the first DRX cycle to save battery power of the UE 102. In response to receiving the DRX command, the UE 102 terminates active time of the at least one consecutive occurrence of the first DRX cycle, e.g., as shown in FIG. 17A or FIG. 17B. In some implementations, the UE 102 refrains from or stops receiving DL signals and/or transmitting UL signals, during the at least one consecutive occurrence to save battery power. In some implementations, the DL signals include reference signals, DL control information (DCIs) and/or Physical DL Shared Channel (PDSCH). For example, the UE 102 can control a (RF) transceiver of the UE 102 to enter a power saving mode during the at least one consecutive occurrence. In another example, the UE 102 can control a baseband of the UE 102 to enter a power saving mode during the at least one consecutive occurrence. The DU 174 refrains from or stops transmitting at least one UE specific signal and/or data for the UE 102 during the at least one consecutive occurrence. In some implementations, the DU 174 includes or indicates the number of consecutive occurrence(s) of the first DRX cycle to be terminated in the DRX command and the UE 102 determines to terminate or terminates the consecutive occurrence(s) of the first DRX cycle in accordance with the number indicated in the DRX command. The DU 174 refrains from or stops transmitting at least one UE specific signal and/or data for the UE 102 during the consecutive occurrence(s) of the first DRX cycle in accordance with the number indicated in the DRX command. In some implementations, the first occurrence of the first DRX cycle to be terminated is the occurrence of the first DRX cycle where the UE 102 receives the DRX command in a slot in the on duration. The UE 102 terminates (the number of) the consecutive occurrence(s) of the first DRX cycle from the first occurrence, e.g., after the slot. This is illustrated in FIG. 17A. In some implementations, the CU-UP 172B might include or indicates the number of consecutive occurrences of the first DRX cycle in the CU-UP-to-DU packet N. For example, the CU-UP 172B includes or indicates the number of consecutive occurrences of the first DRX cycle in the header of the CU-UP-to-DU packet N. In other implementations, the DRX command does not include the number of consecutive occurrence(s) of the first DRX cycle. In such cases, the UE 102 determines to terminate or terminates the first occurrence of the first DRX cycle as shown in FIG. 17B. After the at least one consecutive occurrence passes, the UE 102 starts receiving during the active time of the first DRX cycle as shown FIGS. 17A and 17B.

In other implementations, the DRX command orders the UE 102 to switch to a different DRX cycle (i.e., a second DRX cycle) to save battery power of the UE 102. For example, the second DRX cycle can be longer than the DRX cycle. The UE 102 switches to or applies a second DRX cycle after (e.g., in response to) receiving the DRX command. Similarly, the DU 174 switches to or applies the second DRX cycle after (e.g., in response to) transmitting the DRX command. In some implementations, the UE 102 receives one or more DRX configurations configuring multiple DRX cycles in one or more messages from the base station 104. In some implementations, the message(s) include RRC reconfiguration message(s) and/or RRC resume message(s). The multiple DRX cycles include the first DRX cycle and the second DRX cycle. In addition to the first and second DRX cycles, the multiple DRX cycles might include one or more additional DRX cycles. The base station 104 (e.g., DU 174 or CU-CP 172A) configures a start offset, an on duration, an off duration and/or a DRX cycle length for each of the multiple DRX cycles in the DRX configuration(s). The start offsets, On durations, off durations and/or DRX cycle lengths for the multiple DRX cycles might be different. To identify each of the multiple DRX cycles, the base station 104 might include an ID identifying the corresponding DRX cycle. For example, the base station 104 might include an ID identifying the second DRX cycle in the DRX command. For example, the ID is a logical channel ID defined in a 3GPP specification. In another example, the DU 174 configures, indicates or includes the ID in the DRX configuration configuring the second DRX cycle. The UE 102 identifies the second DRX cycle in accordance with the ID. In some implementations, the CU-UP 172B might include or indicates the ID in the CU-UP-to-DU packet N. For example, the CU-UP 172B includes or indicates the ID in the header of the CU-UP-to-DU packet N.

After receiving the RRC reconfiguration complete message, the UE 102 transmits UL data packets 1, . . . , M associated with the PDU session or QoS flow(s) to the base station 104 via protocols (e.g., NR PDCP 208, NR RLC 206B, NR MAC 204B and NR PHY 202B). M is an integer and larger than zero. The transmission is based on the configuration parameters 336 and uses resources that are assigned to the UE 102. The UE 102 generates UL PDUs (e.g., PDCP PDU or SDAP PDU) 1, . . . , M including the UL data packets 1, . . . , M, respectively. The UE 102 transmits 370, 376A the UL PDUs 1, . . . , M via protocols (e.g., NR RLC 206B, NR MAC 204B and NR PHY 202B) to the DU 174. The DU 174 generates DU-to-CU-UP packets 1, . . . , M including the UL PDUs 1, . . . , M, respectively. The DU 174 transmits 372, 378A the DU-to-CU-UP packets 1, . . . , M to the CU-UP 172B. Each of the CN-to-CU-UP packets 1, . . . , M includes one or more protocol headers. For example, the DU-to-CU-UP packets are GTP-U packets. The protocol header(s) include an IP header, a UDP header, and/or a GTP-U header. The CU-UP 172B retrieves UL data packets 1, . . . , M from the UL PDUs 1, . . . , M, generates CU-UP-to-CN packets including the UL data packets 1, . . . , M and transmits 374, 380 the CU-UP-to-CN packets 1, . . . , M to the CN 110 (e.g., the UPF 162), respectively. For example, the CU-UP-to-CN packets are GTP-U packets. The protocol header(s) include an IP header, a UDP header, and/or a GTP-U header. In some implementations, the CN 110 retrieves the UL data packets 1, . . . , N from the CU-UP-to-CN packets, respectively and transmits the UL data packets to the packet data network.

In some implementations, the UL data packets 1, . . . , M belong to a data burst and the UL data packet M is the last data packet of the data burst. In some implementations, the UE 102 includes an end indication indicating the end of the data burst in the UL PDU M and does not include the end indication in the UL PDUs 1, . . . , M−1. In some implementations, a header of a UL PDU (e.g., the UP PDU packet 1, . . . , M) includes a field indicating whether a UL data packet included in the UL PDU is the last packet of a data burst. For example, the field has two values. A first value of the field indicates the included UL data packet is the last packet of a data burst, and a second value of the field indicates the included UL data packet is not the last packet of a data burst. In such implementations, the UE 102 sets the field in the UL PDU M to the first value and sets the field in the UL PDUs 1, . . . , N−1 to the second value. In other implementations, the UE 102 does not include the end indication in the UL PDU M or does not include the field in the UL PDUs 1, . . . , M.

In the following description, “the end indication in the UL PDU” can be equivalent to “the field in a UL PDU set to the first value”. Similarly, the end indication not included in the UL PDU” can be equivalent to “the field in a UL PDU set to the second value”.

The events 350, 352, 354, 356, 358, and 360 are collectively referred to in FIG. 3A as DL data communication 362. The events 370, 372, 374, 376A, 378A, and 380 are collectively referred to in FIG. 3A as UL data communication 382A.

In some implementations, after (e.g., in response to) transmitting the DL data packet N and/or receiving the UL PDU M (e.g., the end indication in the UL PDU M), the CU-UP 172B transmits 384 a CU-UP-to-DU packet to the DU 174. In some implementations, the CU-UP 172B indicates the end of a data burst, early terminating an inactive time of a DRX cycle, or switching to the second DRX cycle in the CU-UP-to-DU packet 384. In some implementations, CU-UP 172B includes such indication in a header (e.g., GTP-U header) of the CU-UP-to-DU packet 384. In such cases, the CU-UP 172B might or might not include the end indication in the CU-UP-to-DU packet N. In response to receiving the CU-UP-to-DU packet 384 (e.g., the indication), the DU 174 transmits 390 the DRX command, as described above. The UE 102 switches to the second DRX cycle in response to receiving the DRX command, as described above. In the case of early terminating active time of a DRX cycle, the CU-UP 172B might include or indicates the number of consecutive occurrences of the first DRX cycle in the CU-UP-to-DU packet 384. In some implementations, the CU-UP 172B includes or indicates the number of consecutive occurrences of the first DRX cycle in the header of the CU-UP-to-DU packet 384.

In some scenarios or implementations, the UE 102 might have one or more UL data packets available for transmission during the terminated consecutive occurrence(s) of the first DRX cycle. In such cases, the UE 102 transmits a scheduling request to the DU 174 to request data transmission during the terminated consecutive occurrence(s). In response, the DU 174 transmits one or more DCIs to the UE 102. Each of the DCI(s) includes an uplink grant and the UE 102 transmits the UL data packet(s) to the DU 174 using the uplink grant(s). When the UE 102 determines to transmit or transmits the scheduling request, the UE 102 starts or attempts receiving DL signals from the DU 174. In some implementations, the DL signals includes DCIs and reference signals. Each of the DCIs can include an UL grant or DL assignment. The UE 102 transmits the uplink packet(s) using the UL grant(s). The UE 102 receives one or more DL PDUs from the DU 174 in accordance with the DL assignment(s). While receiving the DL signals, communicating the UL packet(s) and/or DL packet(s), the UE 102 may transmit sound reference signals, channel state information (CSI), and/or hybrid automatic repeat request (HARQ) feedback to the DU 174. In some implementations, the UE 102 communicates with the DU 174 in accordance with the first DRX cycle after transmitting the scheduling request or the UL packet(s). Correspondingly, the DU 174 communicates with the UE 102 in accordance with the first DRX cycle after receiving the scheduling request or receiving the UL packet(s). In other implementations, the DU 174 may transmit a DRX command to the UE 102 to switch the UE 102 to the first DRX cycle from the second DRX cycle after receiving the scheduling request, and the UE 102 switches to the second DRX cycle in response to receiving the DRX command.

FIG. 3B illustrates an example scenario 300B similar to the scenario 300A illustrated in FIG. 3A. The differences between the scenarios 300A and 300B are described below. In the scenario 300B, the UE 102 does not include the end indication in the UL PDU M in the event 376B. Thus, the DU 174 does not include the end indication in the DU-to-CU-CP packet in the event 378B. After transmitting 376B the UL PDU M, the UE 102 transmits 381 a UL PDU indicating the end of the data burst to the DU 174. For example, the UE 102 includes, in the UL PDU 381 an end indication indicating the end of the data burst. In another example, the UL PDU 381 includes a field indicating whether a UL data packet included in the UL PDU is the last packet of a data burst. For example, the field has two values. A first value of the field indicates the included UL data packet is the last packet of a data burst, and a second value of the field indicates the included UL data packet is not the last packet of a data burst. In such implementations, the UE 102 sets the field in the UL PDU 381 to the first value. In some implementations, the UE 102 does not include a UL data packet associated with the PDU session or QoS flow in the UL PDU 381. The UE 102 might or might not include a UL data packet not associated with the PDU session or QoS flow in the UL PDU 381. In other implementations, the UE 102 does not include a UL data packet in the UL PDU 381. In some implementations, the UL PDU 381 is a PDCP PDU or a SDAP PDU. The PDCP PDU can be a data PDU or a control PDU. The SDAP PDU can be a data PDU or a control PDU. In such cases, the DU 174 transmits 383 the UL PDU (e.g., the PDCP PDU or SDAP PDU) to the CU-UP 172B. In some implementations, after (e.g., in response to) transmitting the DL data packet N (e.g., the end indication in the DL data packet N) and/or receiving the UL PDU 381 (e.g., the end indication in the UL PDU 381), the CU-UP 172B transmits 384 the CU-UP-to-DU packet to the DU 174.

In other implementations, the UL PDU 381 is a MAC PDU or a RLC PDU. The RLC PDU can be a data PDU or a control PDU. In such cases, the DU 174 does not transmit the UL PDU 381 to the CU-UP 172B. The DU 174 transmits 390 the DRX command to the UE 102 after (e.g., in response to) receiving the UL PDU 381 (e.g., the end indication in the UL PDU 381).

The events 370, 372, 374, 376B, 378B, 380, 381, and 383 are collectively referred to in FIG. 3B as UL data communication 382B.

FIG. 3C illustrates an example scenario 300C similar to the scenarios 300A and 300B illustrated in FIGS. 3A and 3B. The differences among the scenarios 300A, 300B and 300C are described below. In the scenario 300C, the UE 102 does not include the end indication in the UL PDU M in the event 376C. Instead, the UE 102 includes the end indication in a UL lower layer PDU including the UL PDU M. In some implementations, the UL lower layer PDU is a MAC PDU or a RLC PDU (e.g., a data PDU) similar to the event 381. The DU 174 retrieves the UL PDU M from the UL lower layer PDU and transmits 378B the DU-to-CU-UP packet including the UL PDU M to the CU-UP 172B. The DU 174 transmits 390 the DRX command to the UE 102 after (e.g., in response to) receiving the UL lower layer PDU 376C (e.g., the end indication in the UL lower layer PDU 376C).

FIG. 3D illustrates an example scenario 300D similar to the scenarios 300A and 300B illustrated in FIGS. 3A and 3B. The differences among the scenarios 300A, 300B and 300D are described below. In the scenario 300D, the CU-UP 172B transmits 385 a UP-to-CP message to the CU-CP 172A, after (e.g., in response to) transmitting the DL data packet N and/or receiving the UL PDU M (e.g., the end indication in the UL PDU M). In some implementations, the CU-UP 172B indicates the end of a data burst, early terminating an inactive time of a DRX cycle, or switching to a different DRX cycle in the UP-to-CP message. In some implementations, the UP-to-CP message is an E1 application protocol (E1AP) message. In some implementations, the CU-UP 172B might indicate switching to the second DRX cycle in the UP-to-CP message. For example, the CU-UP 172B might include the ID identifying the second DRX cycle in the UP-to-CP message to indicate switching to the second DRX cycle. After (e.g., in response to) receiving the UP-to-CP message, the CU-CP 172A transmits 387 a CU-CP-to-DU message to the DU 174. In some implementations, the CU-CP 172A indicates the end of a data burst, early terminating an inactive time of a DRX cycle, or switching to a different DRX cycle in the CU-CP-to-DU message. In some implementations, the CU-CP 172A might indicate switching to the second DRX cycle in the CU-CP-to-DU message. For example, the CU-CP 172A might include the ID identifying the second DRX cycle in the CU-CP-to-DU message to indicate switching to the second DRX cycle. After (e.g., in response to) receiving the CU-CP-to-DU message, the DU 174 may transmit 390 the DRX command to the UE 102.

FIG. 3E illustrates an example scenario 300E similar to the scenario 300A illustrated in FIG. 3A. The differences between the scenario 300A and 300E are described below. In the scenario 300E, the UE 102 transmits 389 a MAC CE to the DU 174 after performing 362 DL data communication and/or performing 382A UL data communication. In some implementations, the UE 102 may generate a UL MAC PDU including the MAC CE and transmit 389 the UL MAC PDU to the DU 174. In some implementations, the UE 102 requests to early terminate active time (e.g., on duration) of a DRX cycle (e.g., the first DRX cycle) in the MAC CE. In some implementations, the UE 102 might include, in the MAC CE, the number of consecutive occurrence(s) of the first DRX cycle that the UE 102 requests to terminate. In response to receiving the MAC CE, the DU 174 transmits 390 the DRX command to the UE 102 to command the UE 102 to early terminate active time of the at least one consecutive occurrence of the first DRX cycle. In other implementations, the UE 102 requests to switch to a different DRX cycle in the MAC CE. The UE 102 might include the ID identifying the second DRX cycle in the MAC CE to request switching to the second DRX cycle. In response to receiving the MAC CE, the DU 174 transmits 390 the DRX command to the UE 102 to command the UE 102 to switch to the second DRX cycle.

In other implementations, the UE 102 indicates early terminating active time of a DRX cycle (e.g., the first DRX cycle) in the MAC CE. In such cases, the UE 102 early terminates active time (e.g., on duration) of at least one occurrence of the first DRX cycle without receiving a/the DRX command. The DU 174 does not transmit a DRX command to the UE 102 in response to the MAC CE. In some implementations, the at least one occurrence of the first DRX cycle starts from an occurrence of the first DRX cycle where the UE 102 transmits the MAC CE. After receiving the MAC CE, the DU 174 determines that the UE 102 early terminates active time of the at least one consecutive occurrence of the first DRX cycle. In some implementations, the at least one occurrence of the first DRX cycle starts from an occurrence of the first DRX cycle where the DU 174 receives the MAC CE. In some implementations, the UE 102 might include, in the MAC CE, the number of consecutive occurrence(s) of the first DRX cycle that the UE 102 terminates. Thus, the DU 174 determines the UE 102 terminates the number of consecutive occurrence(s).

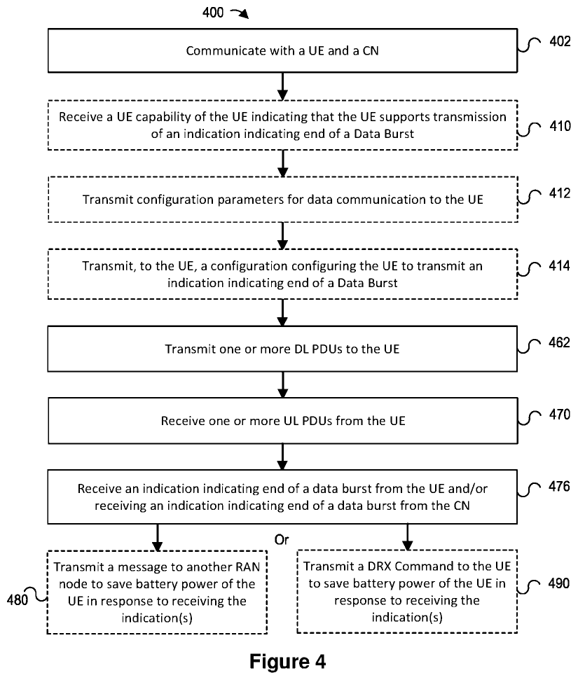

FIG. 4 illustrates an example method 400, which can be implemented by a RAN node (e.g., the base station 104, CU 172, CU-CP 172A or CU-UP 172B), for managing data communication for a UE (e.g., the UE 102) to save battery power of the UE.

The method 400 begins at block 402, where the RAN node communicates with the UE and a CN (e.g., events 302, 304, 326, 340). At block 410, the RAN node receives a UE capability of the UE, indicating that the UE supports transmission of an indication indicating end of a Data Burst (e.g., events 306, 310). At block 412, the RAN node transmits configuration parameters for data communication to the UE (e.g., event 336). At block 414, the RAN node transmits, to the UE, a configuration configuring the UE to transmit an indication indicating end of a Data Burst (e.g., event 336). At block 462, the RAN node transmits one or more DL PDUs to the UE (e.g., events 352, 354, 358, 360, 362). At block 470, the RAN node receives one or more UL PDUs from the UE (e.g., events 370, 372, 376A, 378A, 376B, 382B, 378B, 376C). At block 476, the RAN node receives an indication indicating end of a data burst from the UE (e.g., event 376A, 378A, 382A, 381, 383, 382B, 376C) and/or receive an indication indicating end of a data burst from the CN (e.g., events 382A, 382B, 362). The flow either proceeds to block 480 or block 490. At block 480, the RAN node (e.g., the CU 172, CU-CP 172A or CU-UP 172B) transmits a message to another RAN node (e.g., the DU 174) to save battery power of the UE in response to receiving the indication (e.g., events 384, 387). At block 490, the RAN node (e.g., the base station 104) transmits a DRX Command to the UE to save battery power of the UE (e.g., event 390).

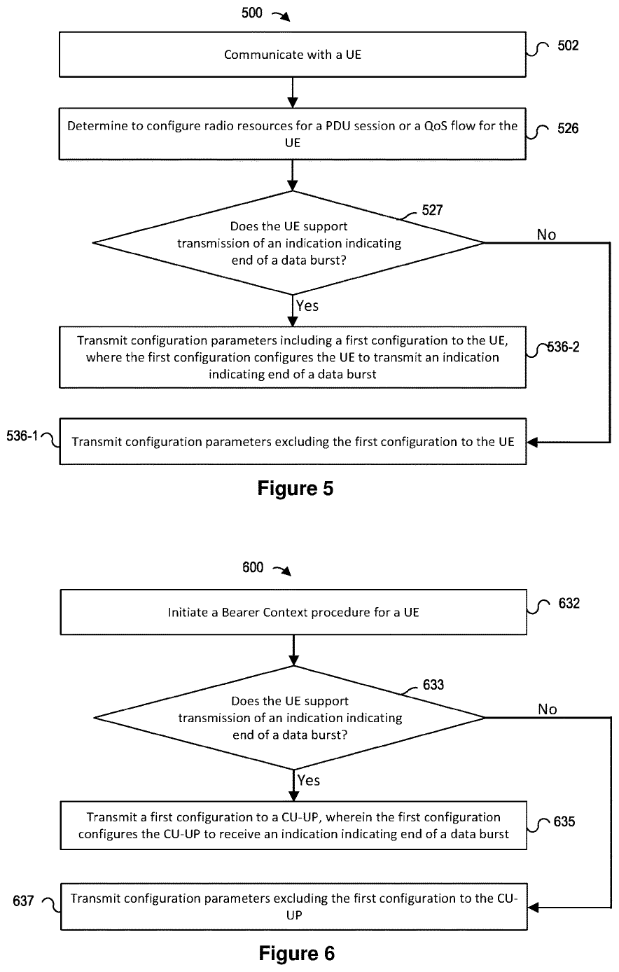

FIG. 5 illustrates an example method 500, which can be implemented by a RAN node (e.g., the base station 104, CU 172, CU-CP 172A or CU-UP 172B), for managing data communication for a UE (e.g., the UE 102) to save battery power of the UE.

The method 500 begins at block 502, where the RAN node communicates with the UE e.g., events 302, 304). At block 526, the RAN node determines to configure radio resources for a PDU session or a QoS flow for the UE. For example, the RAN node determines to configure radio resources for the PDU session or QoS flow for the UE in response to receiving a request message from a CN (e.g., event 326). At block 527, the RAN node determines whether the UE supports transmission of an indication indicating end of a data burst. If the RAN node determines that the UE supports transmission of an indication indicating end of a data burst at block 527, the flow proceeds to block 536-1. At block 536-1, the RAN node transmits configuration parameters including a first configuration to the UE, where the first configuration configures the UE to transmit an indication indicating end of a data burst (e.g., event 336).

Otherwise, if the RAN node determines that the UE does not support transmission of an indication indicating end of a data burst at block 527, the flow proceeds to block 536-2. At block 536-2, the RAN node transmits configuration parameters excluding the first configuration to the UE (e.g., event 336).

FIG. 6 illustrates an example method 600, which can be implemented by a CU-CP (e.g., the CU-CP 172A), for managing data communication for a UE (e.g., the UE 102).

The method 600 begins at block 632, where the CU-CP initiates a Bearer Context procedure for the UE (e.g., events 332, 334). At block 633, the CU-CP determines whether the UE supports transmission of an indication indicating end of a data burst. If the CU-CP determines that the UE supports transmission of an indication indicating end of a data burst at block 633, the flow proceeds to block 635. At block 635, the CU-CP transmits a first configuration to a CU-UP, wherein the first configuration configures the CU-UP to receive an indication indicating end of a data burst from the UE (e.g., event 332). For example, the CU-CP transmits a Bearer Context Request message including the first configuration to the CU-UP. Otherwise, if the CU-CP determines that the UE does not support transmission of an indication indicating end of a data burst at block 633, the flow proceeds to block 637. At block 637, the CU-CP transmits configuration parameters excluding the first configuration to the CU-UP (e.g., event 332). For example, the CU-CP transmits a Bearer Context Request message including the configuration parameters to the CU-UP.

In some implementations, the CU-CP transmits the configuration parameters to the CU-UP at block 635. In some implementations, the configuration parameters include PDCP configuration, SDAP configuration, QoS parameters, DRB configuration, and/or PDU session resource to setup. In some implementations, the CU-CP includes the first configuration in the configuration parameters at block 635.

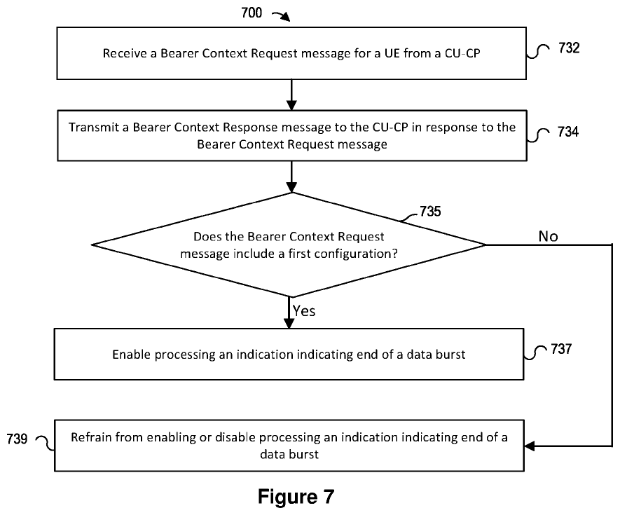

FIG. 7 illustrates an example method 700, which can be implemented by a CU-UP (e.g., the CU-UP 172B), for managing data communication for a UE (e.g., the UE 102).

The method 700 begins at block 732, where the CU-UP receives a Bearer Context Request message (e.g., for a PDU session or a QoS flow) for the UE from a CU-CP (e.g., event 332). At block 734, the CU-UP transmits a Bearer Context Response message to the CU-CP in response to the Bearer Context Request message (e.g., event 334). At block 735, the CU-UP determines whether the Bearer Context Request message includes a first configuration. If the CU-UP determines that the Bearer Context Request message includes the first configuration at block 735, the flow proceeds to block 737. At block 737, the CU-UP enables processing an indication indicating end of a data burst (e.g., events 356, 378A, 383, 382A, 382B). Otherwise, if the CU-UP determines that the Bearer Context Request message does not include the first configuration at block 735, the flow proceeds to block 739. At block 739, the CU-UP refrains from enabling or disable processing an indication indicating end of a data burst.

Example and implementations described for FIG. 6 can apply to FIG. 7.

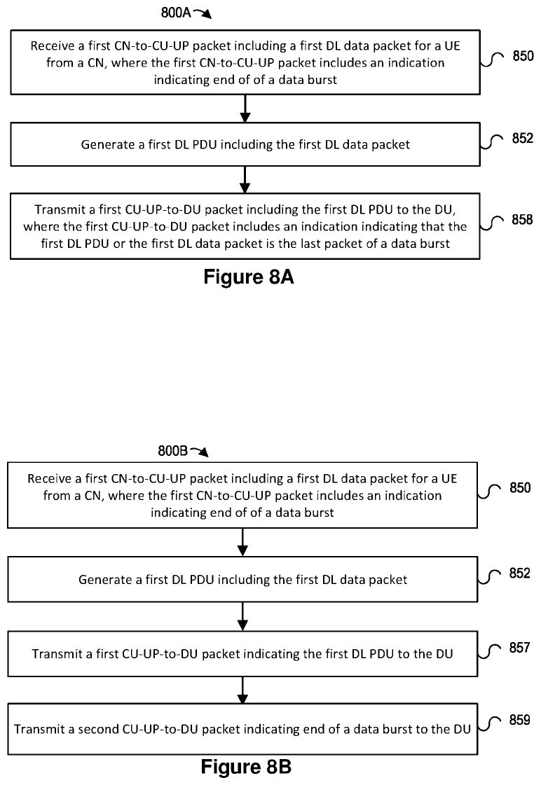

FIG. 8A illustrates an example method 800A, which can be implemented by a CU-UP (e.g., the CU-UP 172B), for managing data communication for a UE (e.g., the UE 102).

The method 800A begins at block 850, where the CU-UP receives a first CN-to-CU-UP packet including a first DL data packet for a UE from a CN, where the first CN-to-CU-UP packet includes an indication indicating end of a data burst (e.g., events 350, 356). At block 852, the CU-UP generates a first DL PDU including the first DL data packet (e.g., events 352, 358). At block 858, the CU-UP transmits a first CU-UP-to-DU packet including the first DL PDU to the DU, where the first CU-UP-to-DU packet includes an indication indicating that the first DL PDU or the first DL data packet is the last packet of a data burst (e.g., events 352, 358).

FIG. 8B is a flow diagram of an example method 800B similar to the method 800A, except that the method 800B includes blocks 857 and 859 instead of block 858. At block 857, the CU-UP transmits a first CU-UP-to-DU packet indicating the first DL PDU to the DU (e.g., event 356). In some implementations, the CU-UP at block 857 refrains from including an end indication indicating the first DL data packet is the last packet of a data burst in the first CU-UP-to-DU packet. At block 859, the CU-UP transmits a second CU-UP-to-DU packet indicating end of a data burst to the DU. In some implementations, the second CU-UP-to-DU packet is a GTP-U packet and the CU-UP includes an end indication indicating end of a data burst in an extension header of the GTP-U header in the GTP-U packet. In other implementations, the second CU-UP-to-DU packet is a control packet.

FIG. 8C is a flow diagram of an example method 800C similar to the method 800B, except that the method 800C includes block 861 instead of block 859. At block 861, the CU-UP transmits a UP-to-CP message indicating end of a data burst to a CU-CP (e.g., event 385).

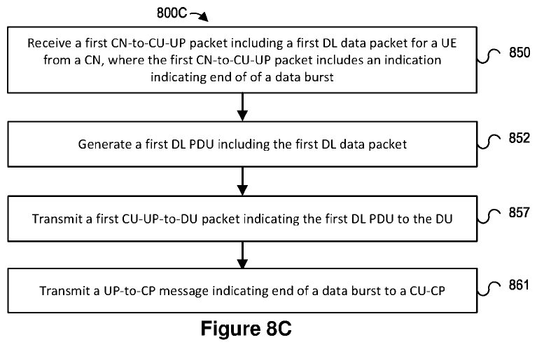

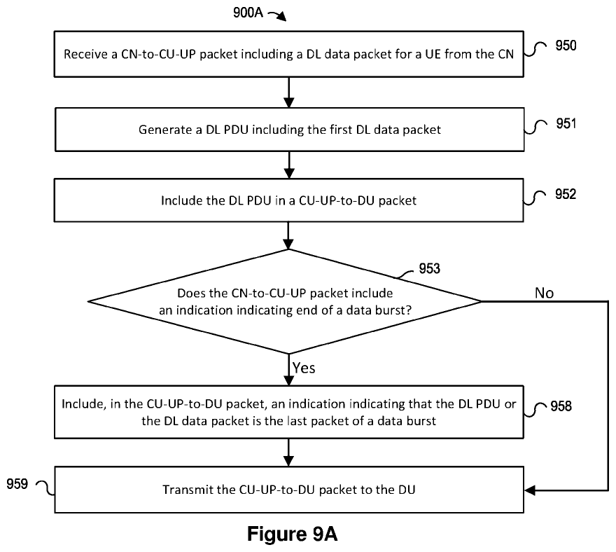

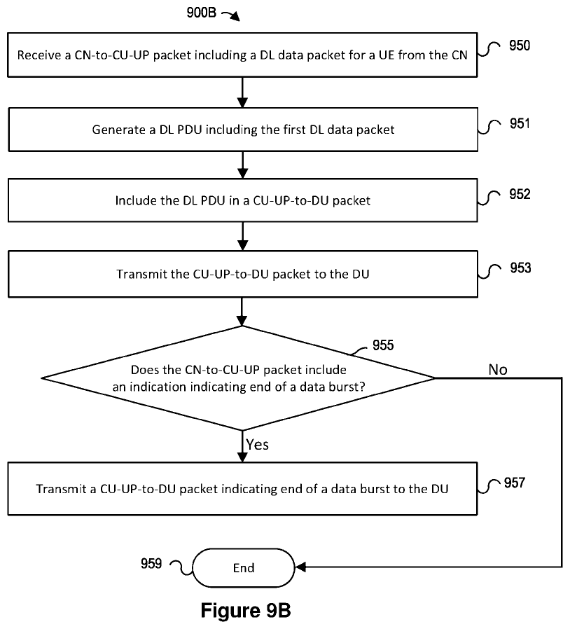

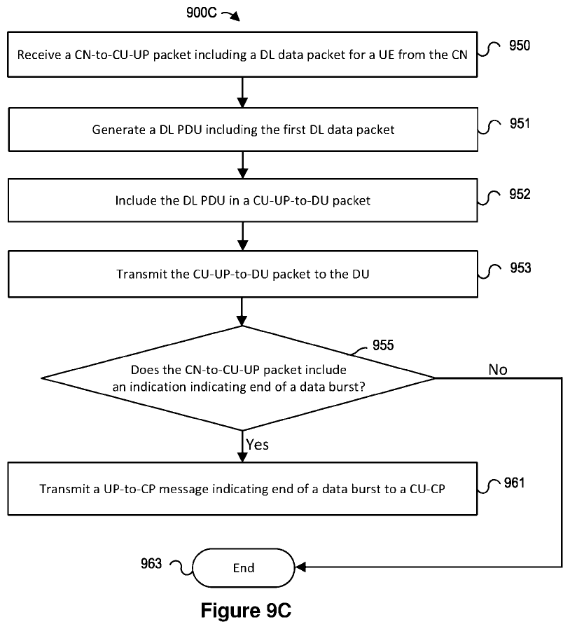

FIG. 9A illustrates an example method 900A, which can be implemented by a CU-UP (e.g., the CU-UP 172B), for managing data communication for a UE (e.g., the UE 102).

The method 900A begins at block 950, where the CU-UP receives a CN-to-CU-UP packet including a DL data packet for the UE from the CN (e.g., event 350, 356, 362). At block 951, the CU-UP generates a DL PDU including the first DL data packet. At block 952, the CU-UP includes the DL PDU in a CU-UP-to-DU packet (e.g., events 352, 358, 362). At block 953, the CU-UP determines whether the CN-to-CU-UP packet includes an indication indicating the DL data packet is the last packet of a data burst. If the CU-UP determines that the CN-to-CU-UP packet includes an indication indicating end of a data burst at block 953, the flow proceeds to block 958. At block 958, the CU-UP includes, in the CU-UP-to-DU packet, an indication indicating that the DL PDU or the DL data packet is the last packet of a data burst (e.g., event 358). Otherwise, if the CU-UP determines that the CN-to-CU-UP packet does not include an indication indicating end of a data burst at block 953, the flow proceeds to block 959. At block 959, the CU-UP transmits the CU-UP-to-DU packet to the DU (e.g., event 352). That is, the CU-UP refrains from including the end indication in the CU-UP-to-DU packet at block 959.

FIG. 9B is a flow diagram of an example method 900B similar to the method 900A, except that the method 900B includes blocks 957 and 959 instead of block 958. The flow proceeds to block 953 from block 951 and then proceeds to block 955. If the CU-UP determines that the CN-to-CU-UP packet includes an indication indicating end of a data burst at block 955, the flow proceeds to block 957. At block 957, the CU-UP transmits a CU-UP-to-DU packet indicating end of a data burst to the DU. For example, the CU-UP-to-DU packet at block 957 can be the second CU-UP-to-DU packet described for FIG. 8B. Otherwise, if the CU-UP determines that the CN-to-CU-UP packet does not include an indication indicating end of a data burst at block 955, the flow proceeds to block 959, where the flows proceeds to the end.

FIG. 9C is a flow diagram of an example method 900C similar to the method 900B, except that the method 900C includes block 961 instead of block 957. At block 961, the CU-UP transmits a UP-to-CP message indicating end of a data burst to a CU-CP (e.g., event 385).

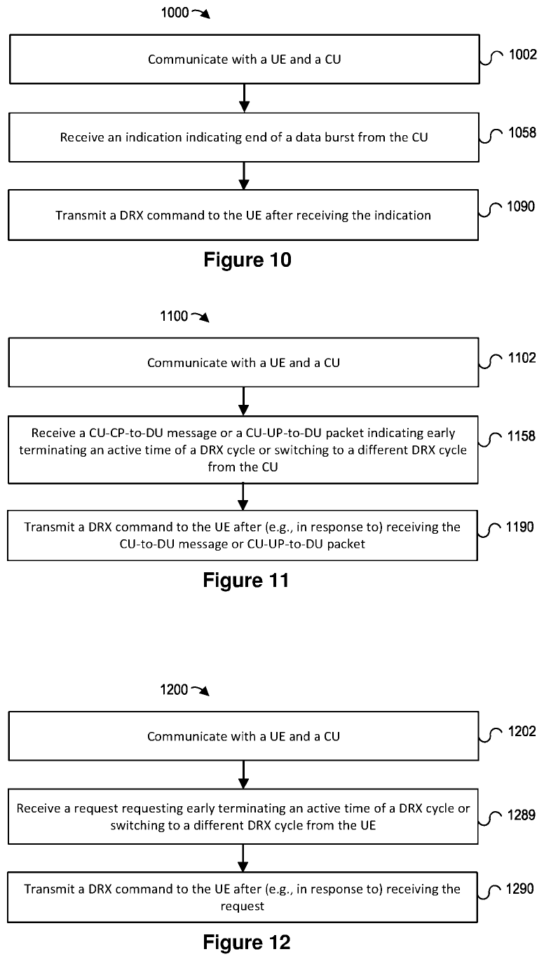

FIG. 10 illustrates a method 1000, which can be implemented by a DU (e.g., the DU 174), for managing data communication with a UE (e.g., the UE 102).

The method 1000 begins at block 1002, where the DU communicates with the UE and a CU (e.g., events 302, 304, 308, 310, 328, 330, 336, 338). The CU can be the CU 172, CU-CP 172A or CU-UP 172B. At block 1058, the DU receives an indication indicating end of a data burst from the CU (e.g., events 358, 362, 384, 387). At block 1090, the DU transmits a DRX command to the UE after (e.g., in response to) receiving the indication (e.g., event 390).

FIG. 11 illustrates a method 1100, which can be implemented by a DU (e.g., the DU 174), for managing data communication with a UE (e.g., the UE 102).

The method 1100 begins at block 1102, where the DU communicates with the UE and a CU (e.g., events 302, 304, 308, 310, 328, 330, 336, 338). The CU can be the CU 172, CU-CP 172A or CU-UP 172B. At block 1158, the DU receives a CU-CP-to-DU message or a CU-UP-to-DU packet indicating early terminating an active time of a DRX cycle or switching to a different DRX cycle from the CU (e.g., events 358, 362, 384, 387). At block 1190, the DU transmits a DRX command to the UE after (e.g., in response to) receiving the CU-to-DU message or CU-UP-to-DU packet (e.g., event 390).

FIG. 12 illustrates a method 1200, which can be implemented by a DU (e.g., the DU 174), for managing data communication with a UE (e.g., the UE 102).

The method 1200 begins at block 1202, where the DU communicates with a UE and a CU (e.g., events 302, 304, 308, 310, 328, 330, 336, 338). At block 1289, the DU receives a request requesting early terminating an active time of a DRX cycle or switching to a different DRX cycle from the UE (e.g., event 389). At block 1290, the DU transmits a DRX command to the UE after (e.g., in response to) receiving the request (e.g., event 390).

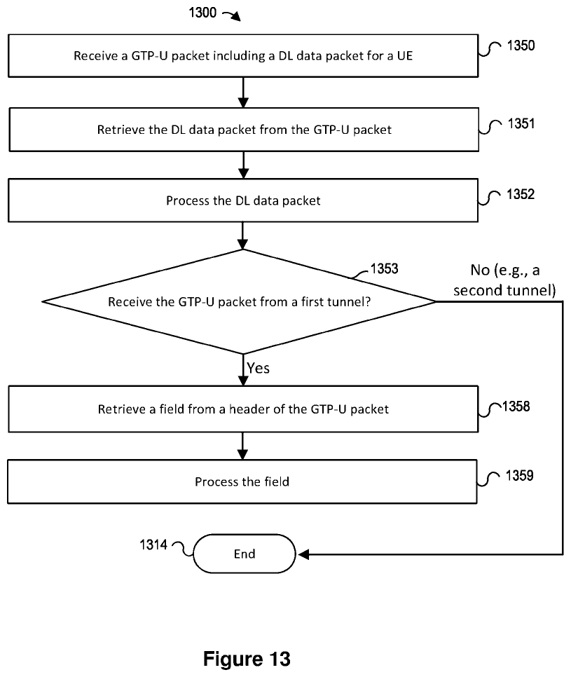

FIG. 13 illustrates an example method 1300, which can be implemented by a RAN node (e.g., the base station 104, CU 172 or CU-UP 172B), for managing data communication for a UE (e.g., the UE 102).

The method 1300 begins at block 1350, where the RAN node receives a GTP-U packet including a DL data packet for a UE (e.g., events 350, 356, 362). At block 1351, the RAN node retrieves the DL data packet from the GTP-U packet. At block 1352, the RAN node processes the DL data packet (e.g., events 352, 358). At block 1353, the RAN node determines whether to receive the GTP-U packet from a first tunnel. If the RAN node determines to receive the GTP-U packet from the first tunnel at block 1353, the flow proceeds to block 1358. At block 1358, the RAN node retrieves a field from a header of the GTP-U packet (e.g., events 352, 358). In some implementations, the field indicates whether a data burst ends, or the DL data packet is the last packet of a data burst. At block 1359, the RAN node processes the field. Otherwise, if the RAN node determines not to receive the GTP-U packet from the first tunnel (e.g., a second tunnel) at block 1353, the flow proceeds to block 1361. At block 1361, the flow proceeds to the end. That is, the RAN node at block 1361 refrains from retrieving or does not retrieve the field from the header of the GTP-U packet.

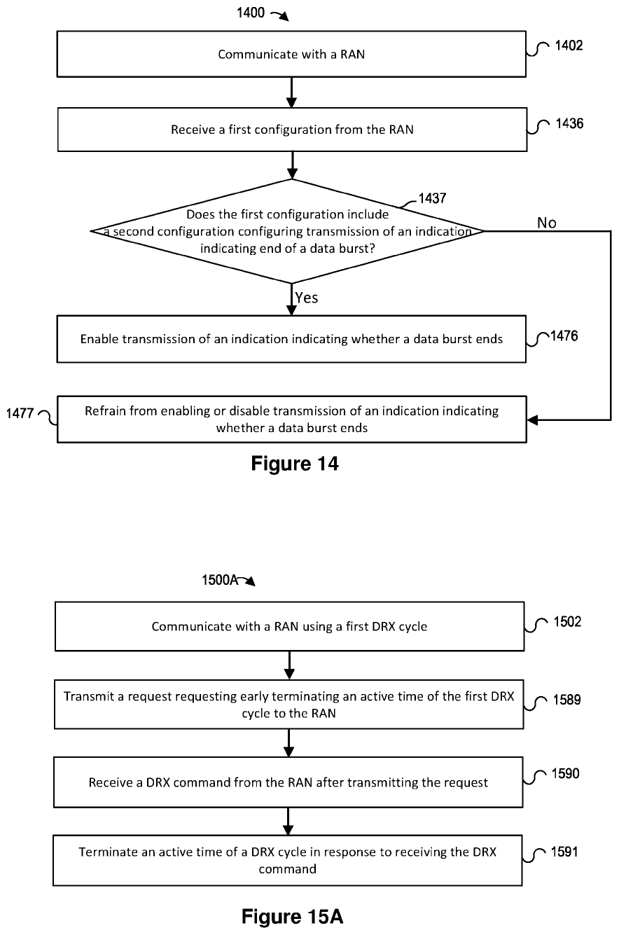

FIG. 14 illustrates a method 1400, which can be implemented by a UE (e.g., the UE 102), for managing data communication with a RAN (e.g., the DU 174, CU 172, base station 104 or 106, or RAN 105).

The method 1400 begins at block 1402, where the UE communicates with the RAN (e.g., events 302, 304, 308, 310). At block 1436, the UE receives a first configuration from the RAN (e.g., event 336). At block 1437, the UE determines whether the first configuration includes a second configuration configuring transmission of an indication of the end of a data burst. If the UE determines that the first configuration includes a second configuration configuring transmission of an indication indicating end of a data burst at block 1437, the flow proceeds to block 1476. At block 1476, the UE enables transmission of an indication indicating whether a data burst ends (e.g., event 376A, 382A, 381, 382B, 376C). Otherwise, if the UE determines that the first configuration does not include a second configuration configuring transmission of an indication indicating end of a data burst at block 1437, the flow proceeds to block 1477. At block 1477, the UE refrains from enabling or disable transmission of an indication whether a data burst ends. In some implementations, the indication can be the end indication or the field described for FIG. 3A.

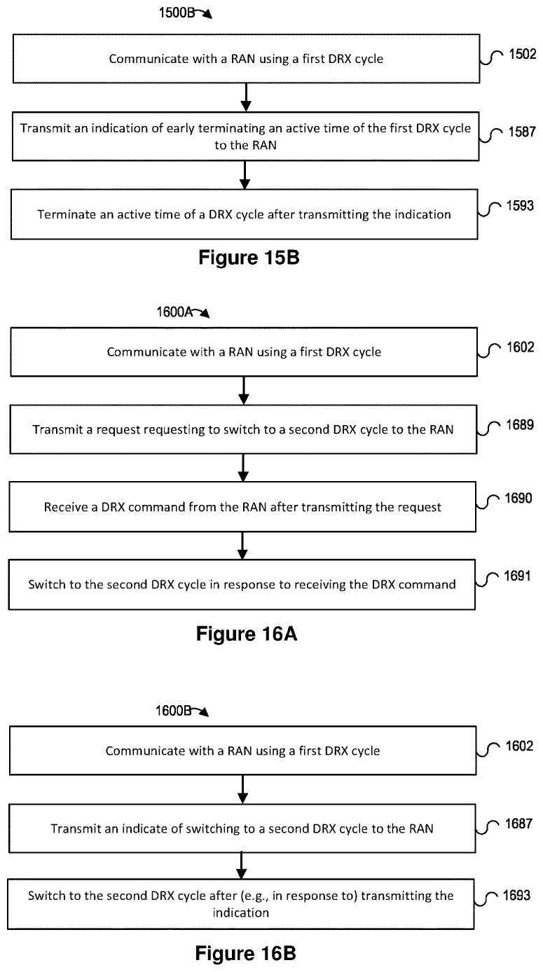

FIG. 15A illustrates a method 1500A, which can be implemented by a UE (e.g., the UE 102), for managing data communication with a RAN (e.g., the DU 174, CU 172, base station 104 or 106, or RAN 105).

The method 1500A begins at block 1502, where the UE communicates with a RAN (e.g., events 302, 304, 308, 310). At block 1589, the UE transmits a request requesting early terminating an active time of a DRX cycle to the RAN (e.g., event 389). At block 1590, the UE receives a DRX command from the RAN after transmitting the request (e.g., event 390). At block 1591, the UE terminates an active time of a DRX cycle in response to receiving the DRX command.

FIG. 15B is a flow diagram of an example method 1500B similar to the method 1500A, except that the method 1500B includes blocks 1587 and 1593 instead of blocks 1589, 1590 and 1591. At block 1587, the UE transmits an indication of early terminating an active time of the first DRX cycle to the RAN (e.g., event 389). At block 1593, the UE terminates an active time of a DRX cycle after (e.g., in response to) transmitting the indication.

FIG. 16A illustrates a method 1600A, which can be implemented by a UE (e.g., the UE 102), for managing data communication with a RAN (e.g., the DU 174, CU 172, base station 104 or 106, or RAN 105).

The method 1600A begins at block 1602, where the UE communicates with a RAN (e.g., events 302, 304, 308, 310). At block 1689, the UE transmits a request requesting to switch to a second DRX cycle to the RAN (e.g., event 389). At block 1690, the UE receives a DRX command from the RAN after transmitting the request (e.g., event 390). At block 1691, the UE switches to the second DRX cycle in response to receiving the DRX command.

FIG. 16B is a flow diagram of an example method 1600B similar to the method 1600A, except that the method 1600B includes blocks 1687 and 1693 instead of blocks 1689, 1690 and 1691. At block 1687, the UE transmits an indication of switching to a second DRX cycle to the RAN (e.g., event 389). At block 1693, the UE switches to the second DRX cycle after (e.g., in response to) transmitting the indication.

Next, several example timing diagrams illustrating messaging timing that may be implemented by devices illustrated in FIGS. 1A and/or 1B are discussed with reference to FIGS. 17A and 17B.

FIGS. 17A and 17B illustrate example scenarios 1700A and 1700B in which a DRX command cuts short an on-duration period. In particular, in scenario 1700A, a UE 102 operates according to DRX cycles 1712-1, 1712-2, 1712-3, . . . , 1712-K, 17120-(K+1), which are collectively referred to as “DRX cycles 1702”. K is a positive integer and larger than 3. Each of the DRX cycles 1702 includes an on-duration period 1714-1, 1714-2, 1714-3A, . . . , 1714-K, and 1714-(K+1) (collectively referred to as “on-duration periods 1714”) as well as an off-duration period 1716-1, 1716-2, 1716-3A, . . . , 1716-K, and 1716-(K+1) (collectively referred to as “off-duration periods 1716”). During the on-duration periods 1714, the UE 102 is active to receive messages and/or data from a RAN 105. During the off-duration periods 1716, the UE 102 is instead inactive to save power when no messages and/or data are expected.

In some implementations, the CU-CP 172A transmits a desired DRX cycle length and/or other information regarding configuring the DRX cycle (e.g., a desired on-duration length, a desired off-duration length, a starting time or offset, etc.) for the UE 102 in a communication to the DU 174. In such implementations, the DU 174 configures the DRX cycle for the UE 102 based on the desired DRX cycle length and/or other information and transmits the DRX configuration(s) to the UE 102. In other implementations, the DU 174 determines a DRX cycle length and/or other information regarding configuring the DRX cycle (e.g., a desired on-duration length, a desired off-duration length, a starting time or offset, etc.) for the UE 102 and transmits the DRX configuration(s) to the UE 102.

In some implementations, the base station 104 can perform an early terminate of one or more occurrences of the DRX cycle for the UE 102. In some such implementations, the base station 104 transmits a MAC PDU scheduled by a DCI with a CRC including the DRX command. In some implementations, the UE 102 receives the DRX command using a UE-specific RNTI, such as a C-RNTI or CS-RNTI. In other implementations, the UE 102 receives the DRX command using an MBS-specific RNTI, such as a G-RNTI or G-CS-RNTI.

In further implementations, a node of the RAN 105, such as the base station 104, monitors data traffic for the UE 102 and configures the length of the on-duration in accordance with the data traffic for the DRX cycle.

As described above, the node can transmit a DRX command to the UE 102 to early terminate one or more occurrences of the DRX cycle. The on-duration period 1714-2 is stopped at t₁ earlier than t₂ in response to receiving the DRX command. In some implementations, the DRX command might terminate one or more additional occurrences of the DRX cycle, such as the occurrences of the DRX cycle 1712-3A, . . . , 1712-K. In such implementations, the DRX command can include or indicate the number of occurrences to be terminated. The number may or may not include the first occurrence, i.e., the occurrence 1712-2. For example, the DRX command includes a number (K−1) to terminate the occurrence of the DRX cycle 1712-2, 1712-3A, . . . , 1712-K. In another example, the DRX command includes a number (K−2) to terminate the occurrence of the DRX cycle 1712-3A, . . . , 1712-K.

Scenario 1700B is similar to scenario 1700A except that the DRX command terminates the on-duration of a single occurrence of the DRX cycle, i.e., the on-duration 1714-2 of the occurrence 1712-2.

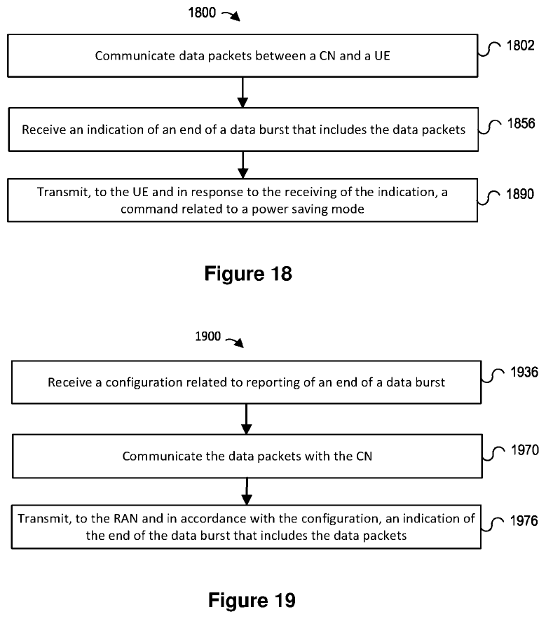

FIG. 18 is as flow diagram of an example method 1800 for communicating downlink packets between a core network (CN) and a user equipment (UE). Method 1800 can be implemented by a RAN node (e.g., the base station 104, CU 172 or CU-UP 172B).

The method 1800 begins at block 1802, with the RAN node communicating data packets between the CN and the UE (e.g., events 362, 382A, 382B, 402, 502).

At block 1856, the RAN node receives, from the CN, an indication of an end of a data burst that includes the data packets (e.g., events 356, 476). The indication can be provided in a field in a header of a CN-to-BS packet enclosing a downlink (DL) data packet (e.g., events 350, 356, 362). In some embodiments, the header is associated with a user plane of a General Packet Radio Service (GPRS) Tunneling Protocol (GTP-U). In some embodiments, the field has a first value indicating that the DL data packet is a non-last packet in the DL data burst. In some embodiments, a second value for this field indicates that the DL data packet is a last packet in the DL data burst.

At block 1890, the RAN node transmits, to the UE and in response to receiving 1806 the indication, a command related to a power saving mode (e.g., events, 390, 490, 1090, 1190, 1290). The command can include a discontinuous reception (DRX) command, although embodiments are not limited thereto and embodiments can include any type of command to enter a power saving mode or to otherwise reduce battery power. The transmitting can include transmission of a CU-to-DU message, although embodiments are not limited thereto.

The DRX command can be included in a media access control (MAC) subheader, a MAC control element (CE), etc. The DRX command can instruct the UE to early terminate an instance of at least one DRX cycle. The DRX command can indicate a number of consecutive of DRX cycles to terminate. The DRX command can instruct the UE to switch to a different DRX cycle longer than a current DRX cycle with which the UE is configured.

Various embodiments can be implemented in one or more component of a distributed base station, where a distributed base station includes a central unit (CU) and at least one distributed unit (DU), as illustrated with reference to FIGS. 3A-3E.

FIG. 19 is a flow diagram of an example method implemented in a UE for communicating data packets between the UE and a CN via a RAN. Method 1800 can be implemented by any type of UE, for example a user device operating as an internet-of-things (IoT) device or a mobile-internet device (MID, without limitation.

The method 1936 begins at block 1902, with the UE receiving, from the RAN (e.g., a RAN node including the base station 104, CU 172 or CU-UP 172B), a configuration related to reporting of an end of a data burst (e.g., events 336, 412, 536-1, 536-2, 1436).

At block 1970, the UE communicates the data packets with the CN (e.g., events 370, 372, 374, 376A, 376B, 376C, 378A, 378B, 378C, 380, 382A, 382B, 383).

At block 1976, the UE transmits, to the RAN and in accordance with the configuration, an indication of the end of the data burst that includes the data packets (e.g., events, 376A, 376B, 376C). The method 1900 can further include receiving, from the RAN and subsequently to the transmitting of the indication of the end of the data burst, a command instructing the UE to switch to a new power saving cycle (e.g., event 390). The command can specify N consecutive DRX cycles to be terminated, N>1. The method 1900 can further include receiving, from the RAN and subsequently to the transmitting of the indication of the end of the data burst, a command instructing the UE to early terminate at least one instance of a DRX cycle.

The method 1900 can further include transmitting, to the RAN and prior to the receiving of the configuration, an indication that the UE supports the reporting of the end of the data burst (e.g., event 310). The method 1900 can further include refraining from at least one of (i) receiving downlink (DL) signals or (ii) transmitting uplink (UL) signals to the RAN, during the instance of the DRX cycle, in accordance with the command from the RAN (e.g., event 1410). The DL signals can include one or more of (i) reference signals, (ii) DL control information (DCI) signals, or (iii) Physical DL Shared channel (PDSCH) signals. The transmitting of the indication can include including the indication in an uplink (UL) Service Data Adaption Protocol (SDAP) protocol data unit (PDU). The SDAP PDU can further include a last one of the data packets associated with the data burst.

The method 1900 can include transmitting, to the RAN and subsequently to the transmitting of the indication of the end of the data burst, a request to modify a DRX operation at the UE. The request to modify the DRX operation can include a request to: (i) early terminate one or more instances of a DRX cycle, or (ii) switch to a new DRX cycle The following list of examples reflects a variety of the embodiments explicitly contemplated by the present disclosure.

Example 1. A method for communicating downlink data packets between a core network (CN) and a user equipment (UE), the method implemented in a radio access network (RAN) node and comprising: communicating, between the CN and the UE, the data packets;
receiving, from the CN, an indication of an end of a data burst that includes the data packets; and transmitting, to the UE and in response to the receiving of the indication, a command related to a power saving mode.

Example 2. The method of example 1, wherein: the indication is a field in a header of CN-to-BS packet enclosing a downlink (DL) data packet.

Example 3. The method of example 2, wherein: the header is associated with a user plane of a General Packet Radio Service (GPRS) Tunneling Protocol (GTP-U).

Example 4. The method of example 2 or 3, wherein: the field having a first value indicates that the DL data packet is a non-last packet in the DL data burst; and the field having a second value indicates that the DL data packet is a last packet in the DL data burst.

Example 5. The method of example 1, wherein the command related to the power saving mode is a discontinuous reception (DRX) command.

Example 6. The method of example 5, wherein the DRX command is included in a media access control (MAC) subheader.

Example 7. The method of example 5, wherein the DRX command is included in a MAC control element (CE).

Example 8. The method of example 5, wherein the DRX command instructs the UE to early terminate an instance of at least one DRX cycle.

Example 9. The method of example 8, wherein the DRX command indicates a number of consecutive of DRX cycles to terminate.

Example 10. The method of example 5, wherein the DRX command instructs the UE to switch to a different DRX cycle longer than a current DRX cycle with which the UE is configured.

Example 11. The method of any of the preceding examples implemented in a central unit (CU) of a distributed base station that further includes at least one distributed unit (DU).

Example 12. The method of example 11, wherein the transmitting of the command related to the power saving mode includes transmitting, to the DU, a CU-to-DU message.

Example 13. A method implemented in a user equipment (UE) for communicating data packets between the UE and a core network (CN) via a radio access network (RAN), the method comprising: receiving, from the RAN, a configuration related to reporting of an end of a data burst; communicating the data packets with the CN; and transmitting, to the RAN and in accordance with the configuration, an indication of the end of the data burst that includes the data packets.

Example 14. The method of example 13, further comprising: transmitting, to the RAN and prior to the receiving of the configuration, an indication that the UE supports the reporting of the end of the data burst.

Example 15. The method of example 13 or 14, further comprising: receiving, from the RAN and subsequently to the transmitting of the indication of the end of the data burst, a command instructing the UE to switch to a new power saving cycle.

Example 16. The method of example 13 or 14, further comprising: receiving, from the RAN and subsequently to the transmitting of the indication of the end of the data burst, a command instructing the UE to early terminate at least one instance of a DRX cycle.

Example 17. The method of example 16, further comprising: refraining from at least one of (i) receiving downlink (DL) signals or (ii) transmitting uplink (UL) signals to the RAN, during the instance of the DRX cycle, in accordance with the command from the RAN.

Example 18. The method of example 17, wherein the DL signals include one or more of: (i) reference signals, (ii) DL control information (DCIs) signals, or (iii) Physical DL Shared Channel (PDSCH) signals.

Example 19. The method of any of examples 16-18, wherein the command specifies N consecutive DRX cycles to be terminated, N>1.

Example 20. The method of example 14 or 15, further comprising: transmitting, to the RAN and subsequently to the transmitting of the indication of the end of the data burst, a request to modify a DRX operation at the UE.

Example 21. The method of example 20, wherein: the request to modify the DRX operation includes a request to: (i) early terminate one or more instances of a DRX cycle, or (ii) switch to a new DRX cycle.

Example 22. The method of any of examples 14-21, wherein: the transmitting of the indication comprises including the indication in an uplink (UL) Service Data Adaption Protocol (SDAP) protocol data unit (PDU).

Example 23. The method of example 22, wherein: the SDAP PDU further includes a last one of the data packets associated with the data burst.

Example 24. An apparatus comprising processing circuitry configured to perform any of the operations of examples 1-23.

Example 25. A method in a radio access network (RAN) for communicating data packets between the RAN and a user equipment (UE), the method comprising: configuring the UE to report an end of a data burst; communicating, with the UE, data packets associated with the data burst; and receiving, from the UE, an indication of the end of the data burst.

Example 26. The method of example 1, further comprising: receiving, from the UE and prior to the configuring of the UE, an indication that the UE supports the reporting of the end of the data burst.

Example 27. The method of example 1 or 2, further comprising: in response to the receiving of the indication, transmitting to the UE, a command to modify a discontinuous reception (DRX) operation at the UE.

Example 28. The method of example 3, wherein the command instructs the UE to early terminate an instance of a DRX cycle.

Example 29. The method of example 4, further comprising: refraining from at least one of (i) receiving downlink (DL) signals or (ii) transmitting uplink (UL) signals to the RAN, during the instance of the DRX cycle, in accordance with the command.

Example 30. The method of example 5, wherein the DL signals include one or more of: (i) reference signals, (ii) DL control information (DCIs) signals, or (iii) Physical DL Shared Channel (PDSCH) signals.

Example 31. The method of any of examples 4-6, wherein the command specifies N consecutive DRX cycles to be terminated, N>1.

Example 32. The method of any of examples 4-6, wherein the command instructs the UE to switch to a new DRX cycle.

The following additional considerations apply to the foregoing discussion.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “at least one” means “one or more”. In some implementations, “PDU Set based QoS handling” can be replaced by “PDU Set handling”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

When implemented in software, the techniques can be provided as part of the operating system, a library used by multiple applications, a particular software application, etc. The software can be executed by one or more general-purpose processors or one or more special-purpose processors.

What is claimed is:

1. A method for communicating downlink, DL, data packets between a core network, CN (110), and a user equipment, UE (102), the method implemented in a central unit, CU (172), of a distributed base station (104), the method comprising:
communicating, between the CN (110) and the UE (102), the data packets (352);
receiving, from the CN (110), a first indication of an end of a data burst that includes the DL data packets (356); and
transmitting, to a distributed unit, DU (174), of the distributed base station and in response to the receiving of the first indication, a second indication of the end of the data burst (358).

2. The method of claim 1, wherein:
the first indication is a field in a header of CN-to-BS packet enclosing one of the DL data packets.

3. The method of claim 1, further comprising:
transmitting to the UE, a discontinuous reception, DRX, command.

4. The method of claim 3, wherein:
the DRX command instructs the UE (102) to switch to a different DRX cycle longer than a current DRX cycle with which the UE (102) is configured.

5. The method of any of the preceding claims, wherein the second indication is included in a General Packet Radio Service, GPRS, Tunneling Protocol user plane, GTP-U, header of a CU-to-DU message.

6. The method of any of the preceding claims, wherein the CU-to-DU message includes a last one of the DL packets in the data burst.

7. The method of claim 6, wherein the second indication is included in a field that has two values, indicating the end of the data burst or not the end of the data burst, respectively.

8. The method of any of the preceding claims, further comprising:
receiving, from the CN (110) and prior to communicating the DL packets, a request to assign resources for a PDU session; and
in response to determining that the distributed base station (104) supports packet data unit, PDU, Set based quality of service, QoS, handling, transmitting, to the UE (102), a configuration for a PDU Set based QoS.

9. A method for communicating downlink, DL, data packets between a core network, CN (110), and a user equipment, UE (102), the method implemented in a distributed unit, DU (174), of a distributed base station (104), the method comprising:
forwarding, from a CU (172) of the distributed base station (104), and to the UE (102), DL data packets;
receiving, from the CU (172), an indication of an end of a data burst that includes the DL data packets; and
transmitting, to the UE (102), a command instructing the UE (102) to switch to a new power saving cycle or to early terminate at least one instance of a DRX cycle.

10. A method implemented in a user equipment, UE (102), for communicating data packets between the UE (102) and a core network, CN (110), via a radio access network, RAN, the method comprising:
receiving, from the RAN, a configuration related to reporting of an end of a data burst ;
communicating the data packets with the CN(110); and
transmitting, to the RAN and in accordance with the configuration, an indication of the end of the data burst that includes the data packets.

11. The method of claim 10, further comprising:
transmitting, to the RAN and prior to the receiving of the configuration, an indication that the UE (102) supports the reporting of the end of the data burst.

12. The method of claim 10 or 11, further comprising:
receiving, from the RAN and subsequently to the transmitting of the indication of the end of the data burst, a command instructing the UE (102) to switch to a new power saving cycle.

13. The method of claim 10 or 11, further comprising:
receiving, from the RAN and subsequently to the transmitting of the indication of the end of the data burst, a command instructing the UE (102) to early terminate at least one instance of a DRX cycle.

14. The method of claim 11 or 12, further comprising:
transmitting, to the RAN and subsequently to the transmitting of the indication of the end of the data burst, a request to modify a DRX operation at the UE (102).

15. An apparatus comprising processing circuitry configured to perform any of the operations of claims 1-14.
